(19) United States
(12) Patent Application Publication
(10) Pub. No.: US 2011/0191166 A1
(43) Pub. Date: Aug. 4, 2011

(54) Leveraging of Financial Transaction Data

(75) Inventors: David JOA, Irvine, CA (US); Debashis GHOSH, Charlotte, NC (US); Kurt NEWMAN, Matthews, NC (US); Mark KREIN, Charlotte, NC (US); Timothy J. BENDEL, Charlotte, NC (US)

(73) Assignee: BANK OF AMERICA CORPORATION, Charlotte, NC (US)

(21) Appl. No.: 12/700,056

(22) Filed: Feb. 4, 2010

(51) Int. Cl. G06Q 30/00; G06Q 10/00; G06Q 40/00

(52) U.S. Cl. 705/14.45; 705/14.52

(57) ABSTRACT

Aspects of this disclosure relate to a system for providing feedback to an advertiser related to the effectiveness of advertising using the transaction data, including one or more organization databases, a transaction data analyzer that analyzes transaction data, an advertisement repository database, and a computer system configured to allow advertisements to be uploaded to the advertisement repository database, to allow the communication of feedback related to advertising effectiveness to the advertiser. Transaction data analyzer may search financial transaction data based on advertiser input, may determine characteristics of the searched financial transaction data, and determine results based on the determined characteristics. Further, the system may communicate the results to the advertiser.

FIELD OF THE DISCLOSURE

Aspects of the present disclosure relate generally to advertising and leveraging of financial transaction data. Particular aspects of the present disclosure relate to providing feedback to an advertiser by leveraging financial transaction data.

### BACKGROUND

Generally, an advertiser who is advertising a good or service attempts to make an advertisement as effective as possible by presenting the advertisement such that a potential customer will take an interest in the advertisement. If the potential customer does not take an interest in the advertisement, then the advertisement may not be effective as it would have been if the customer did take an interest in the advertisement. Hence, such advertisements may not result in increased sales of the good or service. For example, if a customer is distracted and not paying attention to the advertisement, then the advertisement may not be as effective. Similarly, if a particular product or service is advertised to an audience that is unlikely to be interested in that particular product or service, then such advertising will generally be less effective than if that particular product or service is advertised to an audience that is likely to be interested in that particular product or service. Therefore, it would be advantageous to have a system and method which increases the likelihood of the effectiveness of an advertisement by communicating feedback to an advertiser related to the effectiveness of their advertisements.

### SUMMARY

The following presents a simplified summary in order to provide a basic understanding of some aspects of the disclosure. The summary is not an extensive overview of the detailed disclosure. It is neither intended to identify key or critical elements of the disclosure nor is it intended to be used to limit the scope of the claimed subject matter. The following summary merely presents some concepts of the disclosure in a simplified form as a prelude to the description below.

In light of the above, it would be beneficial to provide a system and a method that leverages financial transaction data wherein feedback representing the effectiveness of advertising may be communicated to an advertiser. Therefore, aspects of this disclosure relate to a system for communicating feedback, such as feedback on the effectiveness of advertising, to an advertiser, including a transaction data analyzer, one or more databases which stores information related to one or more financial transactions, and a computer system configured to transmit information to an advertiser and to transmit input to the transaction data analyzer. The transaction data analyzer may search the stored information based on input received from the computer system for financial transaction data. Further, the transaction data analyzer may determine one or more characteristics of the financial transaction data resulting from the search. Further, the transaction data analyzer may determine one or more results related to advertising effectiveness based on the one or more characteristics. Further, the transaction data analyzer may communicate the results to the computer system.

Additional aspects of the disclosure relate to a computer assisted method for leveraging financial transaction data wherein feedback representing the effectiveness of advertising may be communicated to an advertiser. The computer assisted method may communicate results related to advertising effectiveness by electronically searching information related to one or more financial transactions stored in a database based on input received by a transaction data analyzer, and using the transaction data analyzer to determine one or more characteristics of the financial transaction data resulting from the search. The computer-assisted method may further determine results based on the one or more characteristics and communicate the results to a user. The transaction data analyzer may further, during the searching of the information, compare the information related to one or more financial transactions with the received input and determine the one or more characteristics of the financial transaction data resulting from the search based on the comparison.

### BRIEF DESCRIPTION OF THE DRAWINGS

The present disclosure is illustrated by way of example and not limited in the accompanying figures in which like reference numerals indicate similar elements.

FIG. 1A illustrates a suitable operating environment in which various aspects of the disclosure may be implemented.

FIG. 1B illustrates a suitable system in which various aspects of the disclosure may be implemented.

FIG. 2 is a diagram of an illustrative example of an advertising system according to at least one aspect of the present disclosure.

FIG. 3 is a flowchart of an illustrative method for participating in an advertising system according to at least one aspect of the present disclosure.

FIGS. 4A-4C are a series of flow charts which demonstrate illustrative methods for determining information related to a financial transaction according to aspects of the disclosure.

FIG. 5 shows an illustrative screen shot of at least one aspect of the present disclosure.

FIG. 6 shows an illustrative screen shot of at least one aspect of the present disclosure.

FIG. 7 is a flowchart of an illustrative method for providing feedback to an advertiser related to the effectiveness of advertising, according to at least one aspect of the present disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

It is noted that throughout the disclosure, the term bank may be used interchangeably with organization, financial institution, business, etc. The term bank is not intended to be limiting, but rather merely describes a potential embodiment of the disclosure.

Aspects of this disclosure relate to a system and method for advertising. Further, particular aspects of this disclosure relate to a system and method for providing feedback to an advertiser by leveraging financial transaction data. When a customer conducts a transaction (e.g., a financial transaction) with an organization, the organization may present an advertisement to the customer and collect and store information related to the transaction. Additionally, the organization may have a transaction history for the customer. Such information presents an opportunity to provide feedback to an advertiser. It would be advantageous to analyze the information to provide feedback to an advertiser.

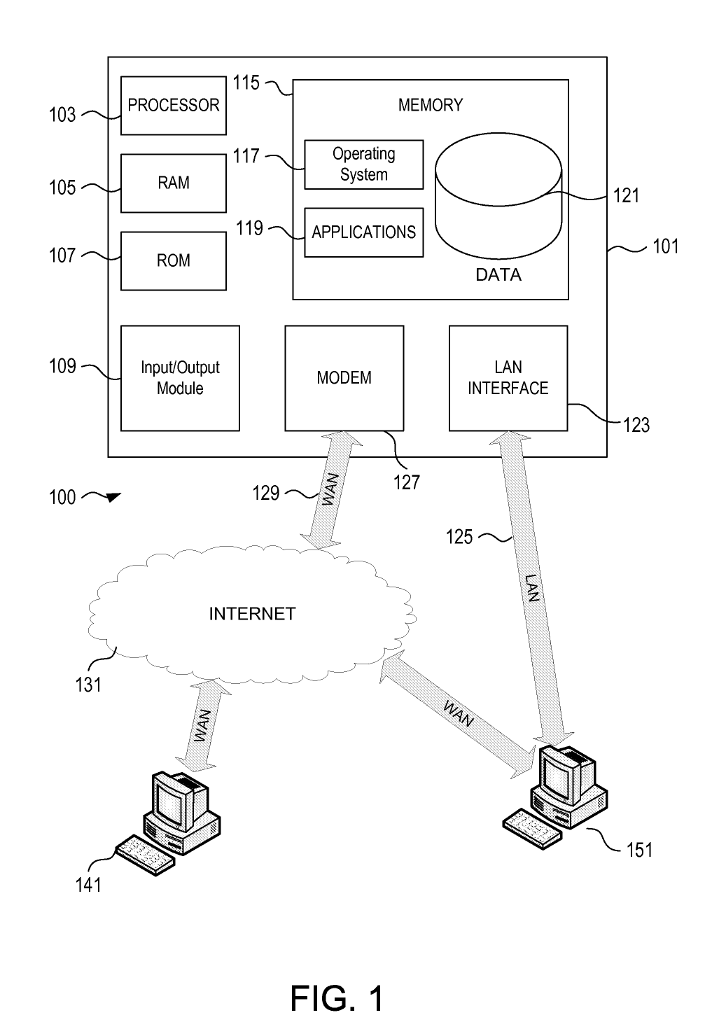

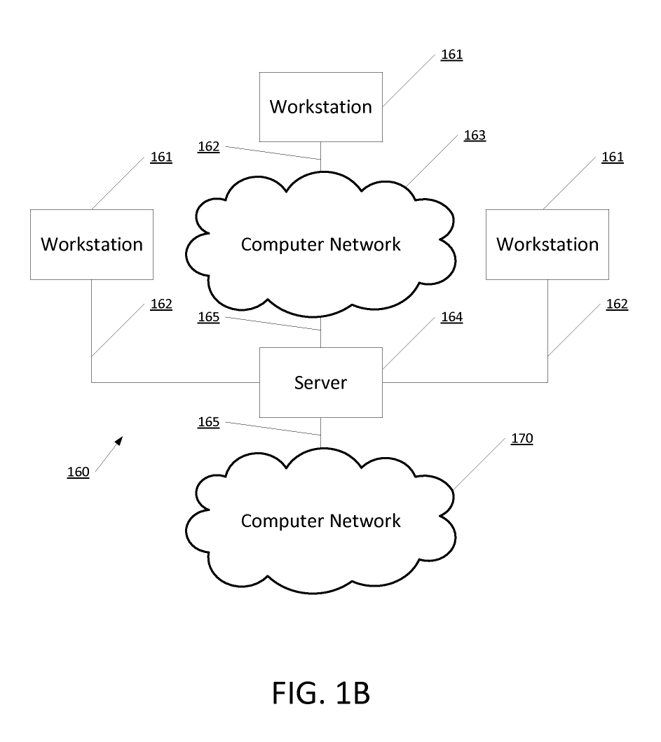

FIG. 1A illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. Neither should the computing system environment 100 be interpreted as having any dependency nor requirement relating to any one or combination of components illustrated in the exemplary computing system environment 100.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

With reference to FIG. 1A, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in Figure lA include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the disclosure may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

FIG. 1B illustrates a suitable system 160 in which various aspects of the disclosure may be implemented. As illustrated, system 160 may include one or more workstations 161. Workstations 161 may be local or remote, and may be connected by one or communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

Computer network 163 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 162 and 165 may be any communications links suitable for communicating between workstations 161 and server 164, such as network links, dial-up links, wireless links, hard-wired links, etc.

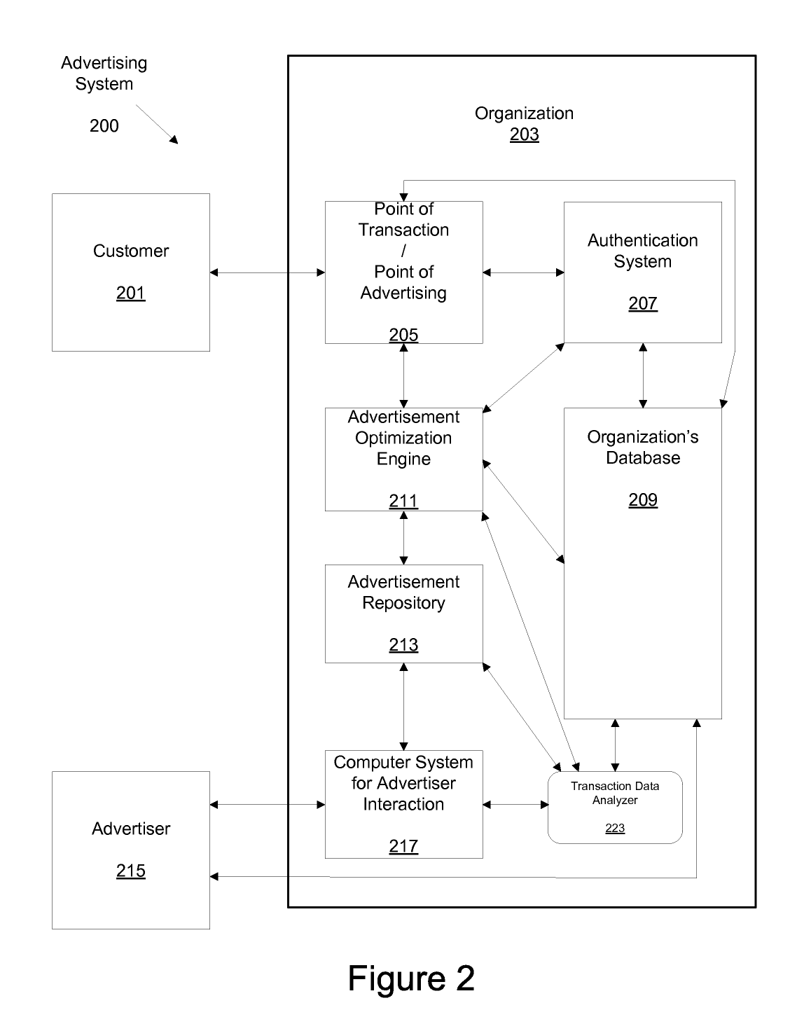

FIG. 2 is a diagram which shows an illustrative advertising system 200 according to aspects of this disclosure. As seen in FIG. 2, a customer 201 conducts a transaction with an organization 203 at a point of sale / point of advertising 205. According to aspects of this disclosure, the customer 201 may have to authenticate their identity in order to conduct the transaction. Therefore, as seen in FIG. 2, the advertising system 200 may include an authentication system 207. The authentication system 207 may transmit data to and receive data from one or more of the organization's databases 209. Further, according to aspects of the disclosure, that advertising system 200 may include an advertisement optimization computer, or engine, 211 and advertisement repository database 213. As seen in FIG. 2, the advertisement optimization engine 211 may transmit data to and receive data from: a point of sale/point of advertising 205, the authentication system 207, one or more of the organization's databases 209, and the advertisement repository 213. Further, according to aspects of the disclosure, that advertising system 200 may include a transaction data analyzer 223. As seen in FIG. 2, the transaction data analyzer 223 may transmit data to and receive data from: the advertisement optimization engine 211, the advertisement repository 213, the computer system for advertiser interaction 217, and the one or more organization's databases 209.

Further, according to aspects of the disclosure, an advertiser 215 may upload an advertisement into a computer system 217 for receiving and transmitting advertisements. It is noted that according to aspects of this disclosure, the computer system 217 may be a web based system. According to aspects of this disclosure, the computer system 217 may transmit data to and receive data from the advertisement repository 213. The above described advertising system 200 represented in FIG. 2 will be described in more detail below. However, it is noted here that one or more of the elements in the above described advertising system 200 (e.g., point of transaction 205, authentication system 207, database 209, advertisement optimization engine 211, advertisement repository 213, computer system 217) may include a computer system with a processor, a memory or both.

According to aspects of this disclosure, during the transaction described above, an advertisement may be presented to the customer 201. Further, it is noted that according to aspects of the disclosure, the above described transaction may be financial transaction. For example, according to aspects of the disclosure, the transaction may be a financial transaction conducted at an Automated Teller Machine (ATM). For example, according to one aspect of the disclosure, if a customer 201 is making a transaction at the ATM, such as a withdrawal, a deposit, a balance inquiry, a transfer of funds, etc., the advertisement could be presented to the customer 201 while the transaction is being processed. For example, once the customer 201 has entered the information required in order for the transaction to be processed (e.g., a Personal Identification Number (PIN), the amount of funds involved in the transaction, etc.), but before the transaction has been completed, there may be a time period during which the transaction is being processed. During such a time period it is likely the customer 201 is paying attention to the ATM (e.g., the customer 201 may be waiting for confirmation that the transaction has been approved and completed). This time period during which the customer 201 is paying attention to the ATM may be an opportune time for presenting the advertisement, because the customer 201 may be a captive audience who must wait until the transaction is completed and receive confirmation from the ATM that the transaction is complete.

According to aspects of this disclosure, the advertisement presented to the customer during the interaction could be a visual advertisement displayed on the screen of the ATM. According to other aspects of the disclosure, the advertisement could be an audio advertisement played through the audio system of the ATM. According to still other aspects of the disclosure, the advertisement could combine both audio and visual aspects. According to aspects of this disclosure, the advertisement presented to the customer during the transaction could be a printed advertisement (e.g., in the form of a receipt) that is that printed out via the ATM's printing system during a time period while the transaction is being processed and before the transaction is complete.

According to aspects of this disclosure, the advertising system 200 may provide the customer 201 an opportunity to get further details about advertisement or the product or service to which the advertisement relates. For example, if the customer 201 wants to get further details about advertisement (or, for example, a coupon related to the advertisement) the customer 201 may have the opportunity to press a button on the ATM (or use a voice recognition system, etc., to communicate the point of transaction 205) to have more information about the advertisement presented (e.g., displayed on the screen, played throughout the audio system, printed out via the ATM's printing system) or sent to the customer (e.g., via mail, email, messaging service (SMS, MMS), etc.). For example, according to aspects of this disclosure, the bank could use address information stored on the ATM card in order to have additional information about the advertisement sent to the customer 201. Also, according to aspects of this disclosure, if the bank already has the customer's contact information, e.g., an email address or phone number (e.g., if the customer 201 is a member of the particular bank that owns the ATM, then the bank may already have such contact information stored in a customer's profile), then the bank may use such customer's contact information in order to have additional information about the advertisement sent to the customer 201. Of course, advertising system 200 may also configure the ATM to allow the customer 201 to enter such contact information into the ATM (e.g., via the ATM keypad or voice recognition service).

According to aspects of this disclosure, alternatively, or in addition to an advertisement being displayed during the actual processing of the transaction, an advertisement may be presented to the customer 201 before and/or after the transaction. For example, the ATM may contain a motion or proximity sensor that determines if a customer 201 approaches the ATM to make a transaction. In response to the sensor's readings, the ATM may automatically present the advertisement. According to another aspect of the disclosure, once the customer 201 has entered their ATM card into the ATM, the advertising system 200 may present a customer 201 with the advertisement prior to continuing on to conducting the transaction (e.g., the customer 201 may be required to view an advertisement, or asked if they wish to view an advertisement, prior to entering a PIN to authenticate and conduct the transaction). According to another aspect of the disclosure, the advertisement may be presented to the customer 201 after the customer 201 has completed the transaction. For example, upon completing the transaction, but prior to returning the customer's ATM card, the advertising system may present a customer 201 with the advertisement (e.g., the customer 201 may be required to view an advertisement, or asked if they wish to view an advertisement).

According to other aspects of the disclosure, the point of interaction 205 may be at a banking center. For example, the point of interaction may be a banking counter at a branch of the bank. In such a situation, the advertisement may be presented on a screen (e.g., an interactive touch screen monitor) in the banking center in the proximity of banking counter (e.g. next to a window of a bank teller with whom the customer 201 is conducting the transaction). According to aspects of the disclosure, an audio system or printer may also be included if desired.

In such an embodiment, the advertisement may be presented to the customer 201 before, during or after a transaction conducted at the banking counter as described above. The details of presenting the advertisement to the customer 201 would be similar to the previously described embodiment and, therefore, will not be elaborated on here for the sake of brevity. According to aspects of the disclosure, alternatively, or in addition to the screen in the banking center, the advertisement may also be presented on a shifting or electronic billboard in the banking center.

According to other aspects of the disclosure, the interaction may be conducted online In such a situation, the point of interaction 205 may be a personal computer (or smart phone) which the customer 201 is using to conduct the interaction. In such an embodiment, the advertisement may be presented on a screen of the personal computer and/or the audio system of the personal computer. In such an embodiment, the advertisement may be presented to the customer 201 before, during or after an interaction conducted at the personal computer as described above. The details of presenting the advertisement to the customer 201 and the details of the transaction data would be similar to the previously described embodiment and, therefore, will not be elaborated on here for the sake of brevity.

According to other aspects of the disclosure, the transaction may be conducted via a telephone. In such a case, the point of interaction 205 may be through a customer service agent or account manager with whom the customer 201 is talking. In such an embodiment, the advertisement may be presented on a screen of a personal computer on which customer service agent or account manager is using to assist the customer 201 conduct the interaction. In such an embodiment, the advertisement may be presented to the customer 201 before, during or after an interaction conducted over the phone through the customer service agent or account manager. In other words, the customer 201 service agent or account manager would read the advertisement on the screen and vocally convey it to the customer 201. The other details of presenting the advertisement to the customer 201 and the details of the transaction data would be similar to the previously described embodiment (however, may be done through the customer service agent or account manager and their personal computer, and the transaction data may indicate as such) and, therefore, will not be elaborated on here for the sake of brevity.

Regardless of type of point of transaction at which the customer 201 conducting the transaction, according to aspects of this disclosure, and as will be discussed in detail below, the point of transaction 205 may transmit data regarding the transaction to the advertisement optimization engine 211. Such transaction data may include the type of transaction (e.g., withdrawal, deposit, balance inquiry, transfer of funds, etc.), the type of point of transaction 205 at which the transaction is being conducted (e.g., ATM, counter transaction, online transaction, telephone transaction, etc.), the location of the point of the transaction 205, the date of the transaction, and time of the transaction, the amount of funds involved in the transaction, etc. According to aspects of the disclosure, the advertisement optimization engine 211 may leverage such information in order to select the particular advertisement to be presented to the customer 201. For example, according to aspects of this disclosure, once the transaction data has been submitted to the advertisement optimization engine 211, the advertisement optimization engine 211 may compare such transaction data with the advertisements stored in the advertisement repository 213 in order to present the customer 201 with an advertisement that is likely to interest the customer 201 (this process will be described in detail below). In such a way, the likelihood of effective advertising is increased.

As discussed above, according to aspects of this disclosure, the user may need to be authenticated in order to conduct the transaction. For example, according to aspects of this disclosure, and as shown in FIG. 2, the advertising system 200 may include an authentication system 207. The authentication system 207 may use a variety of different methods for authenticating the identity of the customer 201. Further, the particular method employed may depend on the particular type of point of transaction 205 through which the transaction is being conducted. For example, in an ATM transaction as described above, in order to be authenticated, the customer 201 may be required to insert an ATM card into the ATM and, also, enter a PIN associated with the ATM card using the keypad of the ATM. Once, the customer 201 has been authenticated, the transaction may be conducted. A similar method may then be employed for a transaction conducted at a banking counter, wherein in order to be authenticated, the customer 201 may be required to swipe an ATM card through a card reader and, also, enter a PIN associated with the ATM card using the keypad of the card reader. According to other aspects of this disclosure, a similar method may be employed for conducting an online transaction. In such an embodiment, in order to be authenticated, the customer 201 may be required to enter an identification number (e.g., a social security number) and a password in order to conduct the transaction. According to other aspects of this disclosure, a similar method may be employed for conducting a telephone transaction. In such an embodiment, in order to be authenticated, the customer 201 may be required to provide the customer service agent or account manage with the identification number and a password in order to conduct the transaction.

According to aspects of this disclosure, other methods of authenticating the user may be used alternatively or, in addition to, the methods described above. For example, according to aspects of this disclosure, biometrics may be used to authenticate a customer 201. For example, biometric authenticating devices, such as retinal scanners, fingerprint scanners, facial recognition cameras, voice authentication audio systems, etc. may be employed in one or more of the above described points of transaction in order to authenticate the customer 201 conducting the transaction.

Regardless of the method employed to authenticate the customer 201 conducting the transaction, according to aspects of this disclosure, and as will be discussed in detail below, information from the authentication may be leveraged in order to select the particular advertisement to be presented to the customer 201. For example, according to aspects of this disclosure, and as seen in FIG. 2, once the customer 201 has been authenticated, the authentication system 207 may transmit data regarding the authentication to the advertisement optimization engine 211 and organization's databases 209. Further, the databases 209 could leverage such information from the authentication to provide the advertisement optimization engine 211 with data regarding the identity of customer 201 and other customer profile information. The advertisement optimization engine 211 may leverage such data including information regarding the identity of customer 201 and other customer profile information in order to present the customer 201 with an advertisement that is likely to interest the customer 201. In such a way, the likelihood of effective advertising is increased. Such aspects of such advertising system 200 will be discussed in detail below.

According to aspects of the disclosure, the advertising system 200 may include a computer system 217 through which advertisers 215 may submit advertisements. For example, according to one embodiment of the disclosure, the advertising system 200 may include a web based system 217 through which advertisers 215 may upload advertisements to be used in the advertising system 200. The web based system 217 may provide several advantages to the advertisers 215 who participate in the advertising system 200. Aspects of this web based system 217 will be described in detail below.

According to aspects of this disclosure, in order for an advertiser 215 to participate in the advertising system 200, the advertiser 215 may be required to register with the organization 203. For example, according to aspects of this disclosure, the advertiser 215 may have to submit particular information to the organization 203 and then be approved by the organization 203 in order to participate in the advertising system 200.

According to an embodiment of the disclosure, wherein the organization 203 is a bank, and the advertiser 215 is a merchant, the merchant may have to become a customer 201 of the bank, create an account with the bank (e.g., a deposit account), provide particular information to the bank, such as contact information, location(s) at which the merchant is located, financial information (e.g., commercial value of the merchant, amount of funds in the merchant's one or more deposit accounts with the bank), etc.

According to aspects of this disclosure, if an advertiser 215 registers with the organization 203, is approved, and becomes an advertiser 215 who is allowed to participate in the advertising system 200, then the advertiser 215 may be allowed to create an advertising account associated with the web based system 217. The advertising account may include several features, such as described below.

Initially, it is noted, that the advertising account may include an authentication system that allows the advertiser 215 to access the advertising account. For example, according to aspects of the disclosure, the advertiser 215 may access the advertising account from personal computer, smart phone, etc. using an identification number and password. Of course, other methods of authenticating the advertiser 215 (e.g., other authentication methods described above) may be used as well.

Once the advertiser 215 has accessed the advertising account, the advertiser 215 may upload the advertisement to advertising account in the advertising system 200. For example, according to aspects of this disclosure, the advertisements 200 may already be in an electronic format (e.g., Protected Document Format (PDF)) and may be uploaded to the advertising account. Once the advertisement has been uploaded to the advertising account, the advertiser 215 may have an opportunity to store the advertisement in the advertising account prior to submitting the advertisement to the organization 203 for use in the advertising system 200.

According to aspects of this disclosure, once the advertisement is submitted to the organization 203 for use in the advertising system 200, the organization 203 may review the advertisement and determine whether the advertisement is acceptable for use in the advertising system 200. For example, the organization 203 may be notified that an advertisement from a particular advertising account has been submitted for approval (e.g., via an automatic email that is generated and transmitted to the organization upon the advertiser 215 submitting an uploaded advertisement for review by the organization 207). The organization 203 may then review the advertisement to determine whether the advertisement is appropriate (e.g., that the advertisement is not offensive), free of mistakes (e.g., provides the merchant's information correctly), conforms to formats that may be required by the advertising system 200 (e.g., dimensions of the advertisement, quality of the image, etc.), etc. If the advertisement is approved by the organization 203, then the advertisement may be transmitted to the advertisement repository 213 and the advertiser 215 may be notified by the organization 203 of the approval (e.g., an email may be sent to the advertiser's advertising account).

As discussed above, once the advertisement has been approved by the organization 203, the advertisement may be transmitted to the advertisement repository 213. The advertisement repository 213 may be a database which stores the approved advertisements from the advertisers 215. Further, the advertisement repository 213 may also store information associated with respective advertisements as will be discussed in detail below. As seen in FIG. 2, the advertisement optimization engine 211 may examine data (e.g., a particular advertisement and/or information associated with the advertisement) in the advertisement repository 213 in order to select an advertisement to be transmitted to the point of transaction 205. Further, the advertisement optimization engine 211 may then retrieve a selected advertisement from the advertisement repository 213 and transmit it to the point of transaction 205 to be presented to a customer 201 during a transaction. According to aspects of the disclosure, the particular advertisement retrieved from the advertisement repository 213 by the advertisement optimization engine 211 may be dependent of various factors, as will be discussed in detail below. It is noted that according to aspects of this disclosure, the advertisements in the advertisement repository 213 may be removed from the advertisement repository 213 upon particular circumstances. For example, the merchant may request the advertisements be removed from the advertisement repository 213, the advertisements may include data associated with the advertisement which instructs the advertising system 200 to remove the advertisement from the advertisement repository 213 upon a certain date (e.g., when the advertisement would expire), etc.

According to aspects of the disclosure, the advertising system 200 may determine information about the transaction conducted at the point of transaction 205 and, further, may transmit such information to the organizations databases 209 to be stored. Further, according to aspects of the disclosure, the advertising system 200 can determine information about the presentation of the advertisement to the customer 201 during the transaction. Further, such information may be also transmitted to and stored in the organizations databases 209. As will be described below, according to aspects of this disclosure, such information regarding the transaction itself and the presentation of the advertisement to the customer 201 during the transaction may be provided to the advertiser 215 as a value added service. The advertiser 215 may be able to leverage such information provided by the advertising system 200 to analyze the effectiveness of their advertisements and potentially modify their advertising strategy.

According to aspects of the disclosure, the advertising system 200 may determine information about a transaction that was conducted including: the type of transaction conducted, the type of point of transaction through which the transaction was conducted, the date the transaction was conducted, the time the transaction was conducted, the location at which the transaction was conducted, the length of time over which the transaction was conducted, the amount of funds involved in the transaction, etc. For example, according to one embodiment of this disclosure, the transaction may have been conducted at an ATM. The point of transaction 205 (in this case the ATM) may transmit such information to the organization's database 209. The database 209 may store such information. Further, according to aspects of the disclosure, the advertising system 200 may determine and store data regarding how frequently an advertisement was presented to customers. For example, according to aspects of the disclosure, each time an advertisement is presented to a customer 201 during a transaction with the advertising system 200, the organization's database 209 may receive data from the advertisement optimization engine 211 and the point of transaction 205 regarding which advertisement was selected from the advertisement repository 213 to be presented to the customer 201 during the transaction. Such information may be stored in the organization's database 209.

According to aspects of the disclosure, the advertising system 200 may determine further information about the presentation of the advertisement to the customer 201 during the transaction. For example, according to aspects of the disclosure, the advertising system 200 may determine if the customer 201 inquired about further information regarding the advertisement. For example, in the embodiment relating to a transaction conducted at an ATM, according to aspects of the disclosure, the advertising system 200 may have presented an advertisement that allowed the customer 201 to view or hear more information by pushing a button on the ATM. In such an embodiment, if customer 201 pressed the button to learn more about the advertisement, then such information may be transmitted back to the organization's database 209 to be stored. Further, if the advertisement had multiple screens such that the customer 201 would have to press the button on the ATM several times in order to view the entire advertisement, such information about whether a portion or the entire advertisement have been viewed may be transmitted back to the organizations database 209 to the stored. Similarly, in a situation wherein the customer 201 requested more information about the advertisement to be sent to the customer 201 (e.g., via information being printed at the ATM, mailed to the user through regular mail, email, SMS, etc.) (or, in the case, wherein a coupon is associated with the advertisement, the customer 201 requested the coupon) such information could also be may be transmitted back to the organization's database 209 to be stored.

According to aspects of the disclosure, the advertising system 200 may determine further information about the presentation of the advertisement to the customer 201 during the transaction. For example, according to aspects of the disclosure, the advertising system 200 may determine how long the customer 201 viewed the advertisement. For example, in the embodiment relating to a transaction conducted at an ATM, according to aspects of the disclosure, the advertising system 200 may have presented an advertisement that allowed the customer 201 to skip over the advertisement by pushing a button the ATM. In such an embodiment, if customer 201 pressed the button to skip over the advertisement, then such information may be transmitted to the organization's database 209 to the stored. Further, if the customer 201 paid attention to a portion of the advertisement before deciding to skip the advertisement, such information about the portion of the advertisement and the length of time associated with it may be stored and transmitted back to the organization's database to the stored. It is noted that a real clock time may be included in the system and used to calculate the length of time.

As described above, according to aspects of this disclosure, transactions conducted at a point of transaction 205, such as transaction conducted at a banking center (e.g., at a banking counter), online, over a telephone, etc. may determine the same information about the transaction and the presentation of the advertisement to the customer in a similar manner to that described above. Further, such information about the transaction (e.g., type of transaction, type of point of transaction, date, time, location, the length of time over which the transaction was conducted, the amount of funds involved in the transaction, etc.) and about the presentation of the advertisement to the customer during the transaction (e.g., how many times the advertisement was retrieved by the advertisement optimization engine 211 to be presented, if the customer 201 requested further information at the point of the transaction 205, if the customer 201 requested further information be sent to them (e.g., via information being printed at the point of transaction, mailed to the user through regular mail, email, SMS, etc.), if the customer 201 requested a coupon, if the customer 201 paid attention to a portion or the entirety of the advertisement, etc.) may be transmitted to the organization's database 209 to be stored in a manner such as described above. The details of obtaining the information about the transaction and the information about the presentation of the advertisement during the transaction would be similar to the previously described embodiment and, therefore, will not be elaborated on here for the sake of brevity.

Once the information about the transaction (e.g., type of transaction, type of point of transaction, date, time, location, the length of time over which the transaction was conducted, amount of the funds involved in the transaction, etc.) and about the presentation of the advertisement during the transaction (e.g., how many times the advertisement was retrieved by the advertisement optimization engine 211 to be presented, if the customer 201 requested further information at the point of the transaction, if the customer 201 requested further information be sent to them (e.g., via information being printed at the point of transaction, mailed to the user through regular mail, email, SMS, etc.), if the customer 201 requested a coupon, if the customer 201 paid attention to a portion or the entirety of the advertisement, etc.) has stored in the organization's database 209, then, as seen in FIG. 2, the information may be transmitted to the advertiser 215 of the particular advertisement. For example, according to aspects of the disclosure, the information may be transmitted to the particular advertiser's advertising account (e.g., via email or other electronic transmissions).

The above described information about the transaction and about the presentation the advertisement 215 to the customer during the transaction may be useful to the advertiser 215. The advertiser 215 may analyze the information to determine many aspects related to the effectiveness of the advertisement. For example, if the advertisement is more effective in particular location, during a particular time of day, or time of the year or month, if a particular advertisement is viewed for a longer amount of time or by a larger group of people than a second of the advertiser's advertisement, etc. The advertiser 215 could then leverage such information in order to determine if the advertiser 215 should consider modifying one or more of their advertisements or their entire advertising campaign in order to increase its effectiveness.

It is noted, in the situation wherein a customer 201 of the transaction obtains a coupon from the advertisement (e.g., if a coupon is emailed, sent via SMS, or printed at the point of the transaction) through the advertising system 200, according to aspects of the disclosure, an identifier of the point of the transaction that provided the coupon (along with other data, e.g., the date and time of the transaction) may be embedded in the coupon. For example, in an ATM transaction wherein the customer 201 requests for the coupon to be sent to their phone via SMS (or printed at the ATM via the ATM's printing system), then the coupon may include an alphanumerical code, data glyph, bar code, etc. which contains the information such as, the location of the transaction wherein the advertisement was presented (e.g., a location of an ATM), the date and time of the transaction, etc. Therefore, when that coupon is used for a purchase and the coupon is returned to the advertiser 215, the advertiser 215 will be able obtain valuable information from the coupon. In other words, according to aspects of the disclosure, when coupons obtained from advertisements presented via the advertising system 200, are actually used for purchase and returned to the advertiser 215, the advertiser 215 will be able to determine, first, that the advertising was effective because the coupon was actually obtained and used in making a purchase related to the advertising, and, additionally, details about the transaction during which the effective advertising was presented to the customer 201, such as the location at which the effective advertising was presented; the date and time of the transaction, etc. The advertiser 215 could then leverage such information in order to determine if the advertiser 215 should consider modifying one or more of their advertisements or their entire advertising campaign in order to increase its effectiveness.

According to aspects of the disclosure, the organization 203 may charge the advertiser 215: a fee for participating in the advertising system 200, a fee for each advertisement submitted, etc. According to aspects of the disclosure, the advertising account of an advertiser 215 may be electronically linked with a financial account that the advertiser 215 has with the organization 203 (e.g., a deposit account). Therefore, the fees for the advertising may be directly withdrawn from the financial account associated with the advertising account of the advertiser 215. It is noted, of course, that in other embodiments the advertiser 215 may simply be billed (e.g., via mail) for the fees associated with advertising the advertisement.

According to aspects of the disclosure, the organization 203 may charge the advertiser 215 a fee for each time an advertisement is presented to a customer 201. As described above, according to aspects of the disclosure, the advertising system 200 may determine and store data regarding how frequently an advertisement was presented to customers. Further, such information may be leveraged by the organization 205 to charge the advertiser 215 of the particular advertisement for each time the advertisement was presented to a customer 201 with the advertising system 200. Therefore, as described above, since the financial account is associated with the advertising account, the fees for the advertising may be directly withdrawn from the financial account associated with the advertising account of the advertiser 215. Such a feature of the advertising system 200 may be particularly advantageous for the organization 203 because the organization 203 would know precisely how many times the advertisements are being presented and can determine how best to charge fee to the advertisers 215 for participating in the advertising system 200 (e.g., a flat fee, a fee for each advertisement submitted, a fee for each presentation of the advertisement).

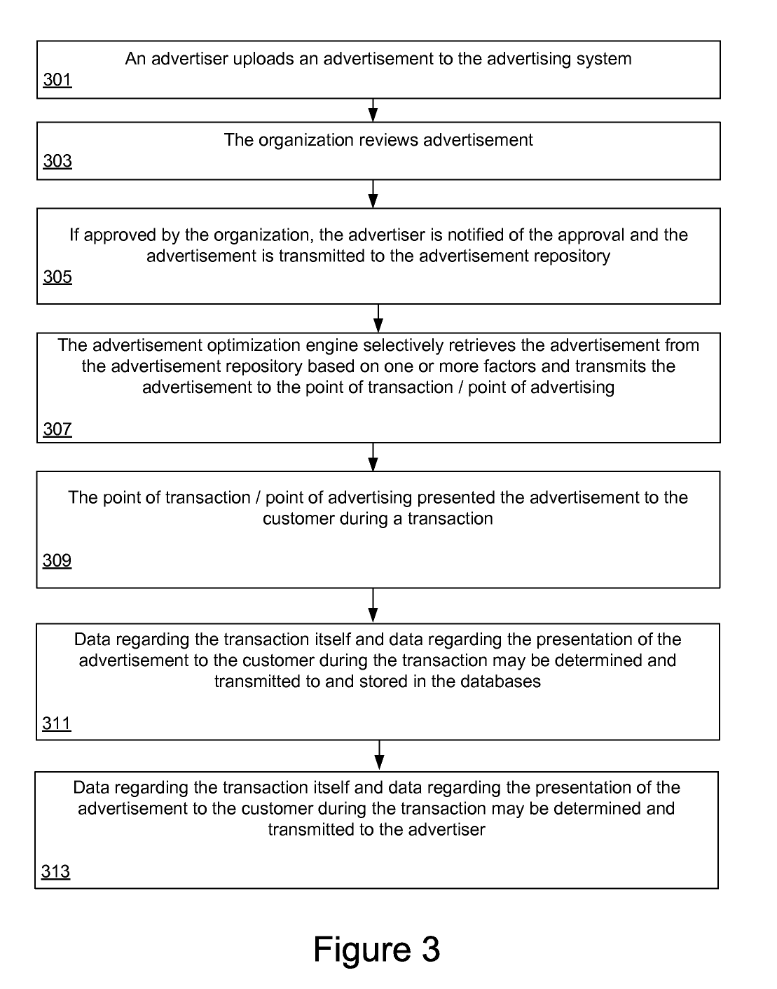

FIG. 3 is a flow chart which demonstrates an illustrative method for participating in an advertising system according to an aspect of the disclosure. As seen in FIG. 3, in step 301 an advertiser 215 uploads an advertisement. In step 303, the organization 203 reviews the advertisement. In step 305, if the advertisement is approved, the advertiser 215 is notified of the approval and the advertisement is transmitted to the advertisement repository 213. In step 307, the advertisement optimization engine 211 selectively retrieves the advertisement from the advertisement repository 213 based on one or more factors and transmits the advertisement to the point of transaction / point of advertising 205. In step 309, the point of transaction/point of advertising 205 presents the advertisement to the customer during the transaction. In step 311, data regarding the transaction itself and the presentation of the advertisement to the customer during the transaction is determined and transmitted to and stored in the databases. In step 313, data regarding the transaction itself and the presentation of the advertisement to the customer during the transaction is transmitted to the advertiser 215.

As will be understood from the above description, the advertising system 200 provides several benefits for the advertisers 215 who participate in the advertising system 200. For example, according to aspects of the disclosure, the advertising system 200 includes a web based system 217 wherein advertisers 215 can easily and conveniently create advertisements and have them advertised to potential customers. Further, the advertising system 200 provides the advertisers 215 with ability to quickly create advertisements and have them presented to potential customers within a short time period. Additionally, according to aspects of the disclosure, the advertising system 200 may also provide the advertisers 215 with the ability to quickly cease the advertisements. For example, according to aspects of the disclosure, the advertisers 215 may withdraw an advertisement from the advertisement repository 213 immediately upon accessing their advertising account. Further, according to aspects of the disclosure, the advertisers 215 may set a limit on the amount of advertisements or coupons that may be presented by the advertising system 200. It is noted that, according to aspects of this disclosure, the advertising system 200 is able to determine that amount of times the advertisement has been presented and the amount of coupons that have been presented and will cease presenting them once the predefined limit has been reached.

Further, it is noted that aspects of the advertising system 200 may be especially beneficial for small business owners/merchants who have limited advertising budgets. For example, the small business may be able quickly and efficient create an advertisement, upload the advertisement to the advertising system 200, and have the advertisement presented to potential customers without incurring the relatively large expense that may be associated with traditional marketing campaigns. Further, aspects of this disclosure may relate to a franchise/franchisee type relationship. For example, a national franchise with hundreds or thousands of locations throughout the country may create an advertising account with the bank. Through this advertising account, the franchise could participate in the advertising system 200 (e.g., upload advertisements, etc.). Further, such a franchise may include individual franchisees which own and operate the various locations of the franchise throughout the country. The franchise may act as an intermediary between the franchisees and the advertising system 200, so that the individual franchisees may participate in the advertising system 200. For example, according to one aspect of the disclosure, the franchisees may be eligible for their own sub account associated with the national franchise's advertising account in the advertising system 200. The individual franchisee's may operate their account in a manner similar to the manner described above for the advertising account, however, according to aspects of the disclosure, the transactions may have to be approved by the national franchise in order to be transmitted further into the advertising system 200. For example, if an individual franchisee uploaded an advertisement for his individual franchise to the sub account, then the advertisement may have to be reviewed and approved by the national franchise through the national franchise's advertising account in the advertising system 200 to ensure the advertisement meets franchise guidelines, (e.g., does not bind other individual franchisees, does not harm the national franchise reputation, etc.). If approved by the national franchise, the advertisement may be uploaded to the advertising system 200 through the national franchise's advertising account. It is noted that, is desired, the franchisee's advertisement could be limited by various characteristics, such as the geographic locations around the individual franchisee (e.g., 6 mile radius of the franchisee's location), customers who have purchased from the individual franchise, etc.

Further, another benefit of the advertising system 200 is that it may provide feedback to the advertiser 215 on the effectiveness of the advertisement. For example, as described above, the advertising system 200 can record data about the transaction and about the presentation of the advertisement 215 during the transaction. The information may be transmitted to the advertiser 215 so that the advertiser 215 may analyze the information to determine many aspects related to the effectiveness of the advertisement.

Another benefit of the advertising system 200 as will be described in detail below is that aspects of the advertising system 200 allow the advertisers 215 who participate in the advertising system 200 to be able to focus their advertising to target particular audiences. It is noted that generally, advertising is more effective when it is targeted to an audience that is likely to be interested in the product or service that is being advertised. For example, if a particular product or service is advertised to an audience that is unlikely to be interested in that particular product or service, then such advertising will generally be less effective than if that particular product or service is advertised to an audience that is likely to be interested in that particular product or service. Therefore, aspects of the advertising system 200 are directed to an advertisement optimization engine 211 which may increase the effectiveness of an advertisement by presenting the advertisement to an audience that is likely to be interested in that particular product or service.

As discussed above, according to aspects of the disclosure, the advertising system 200 may include an advertisement optimization engine 211. Further, as discussed above, according to aspects of the disclosure, during the transaction, information regarding the transaction itself may be transmitted to the advertising optimization engine 211. Further, as discussed above, according to aspects of the disclosure, during the transaction the user may be authenticated and, according to aspects of the disclosure, during the transaction, information regarding the customer who is conducting the transaction may be transmitted to the advertising optimization engine 211. According to aspects of this disclosure, the advertisement optimization engine 211 may leverage such information in determining which advertisement to display to the customer 201 during a transaction. Such features of the advertising system 200 and the advertisement optimization engine will be described in detail below.

According to aspects of the disclosure, the advertising system 200 may allow the advertiser 215 the ability to selectively present advertisements to customers 201 based on a number of factors which are designed to increase the likelihood that the advertisement will be presented to a customer 201 who is interested in the product or service. For example, according to aspects of the disclosure, the advertising system 200 may allow the advertiser 215 the ability to selectively present advertisements to customers 201 based on the customer's transaction history, age, income level, credit scores, deposit account balance, address information, sex, etc.

Further, according to aspects of the disclosure, the advertising system 200 may allow the advertiser 215 the ability to selectively present advertisements to customers 201 based on other factors such as characteristics of the transaction itself (e.g., the type of the transaction, the type of point of transaction through which the transaction is conducted, the date of the transaction, the time of the transaction, the location of the transaction, the location of the transaction in relation to its proximity to one of the advertiser's location, etc.). By allowing the advertiser 215 the ability to selectively target the advertising, aspects of the advertising system 200 may increase the effectiveness of an advertisement by presenting the advertisement to an audience that is likely to be interested in that particular product or service. Further, according to aspects of the disclosure, the advertising system 200 may allow the advertisements of the advertiser 215 to be selectively presented to customers 201 based on feedback determined by the advertising system 200. For example, as discussed above, the advertising system 200 may determine feedback regarding an advertiser's advertisements (e.g., how many times an advertisement is viewed, how long an advertisement is viewed, if an advertisement is skipped, etc.). According to aspects of the disclosure, if the advertising system 200 determines that a first advertisement of a particular advertiser 215 is more successful than a second advertisement of a particular advertiser 215 (e.g., as determined by the above factors), then the advertising system 200 may refrain from presenting the second advertisement and begin displaying the first advertisement in place of the second advertisement. Such a situation can be requested and defined by the advertiser 215 via their advertising account or done automatically by the advertising system through an algorithm.

According to aspects of the disclosure, the advertising system 200 may include a feature that allows the advertiser 215 to enter characteristics of the intended audience to which the advertiser 215 would like the advertisement displayed. For example, according to aspects of the disclosure, an advertiser's advertising account for submitting advertisements to the organization's advertising system 200 may include features which allow the advertiser 215 to enter characteristics of the intended audience to which the advertiser 215 would like the advertisement displayed. For example, the advertiser's advertising account may be part of a web based system 217 and include fields for the advertiser 215 to enter characteristics of the intended audience to which the advertiser 215 would like the advertisement displayed.

According to aspects of the disclosure, such characteristics of the intended audience may include information regarding the transaction itself. For example, such characteristics regarding the transaction itself may include: the type of transaction being conducted during which the advertisement is to be presented (e.g., withdrawal, deposit, balance inquiry, account transfer), the type of point of transaction through which the transaction is conducted, the location of the point of transaction where the transaction is being conducted, a date range during which the advertisement is to be presented (e.g., November 20- November 28), a range of a time of day during which the advertisement is to be presented (e.g., 7:00 pm. to 3:00 am), the proximity of the point of transaction to one of the merchants location, a range of the amount of funds involved in the transaction, etc.

According to aspects of the disclosure, such characteristics may also include information about the customer 201 who is conducting the transaction. For example, such characteristics about the customer 201 who is conducting the transaction may include: the customer's transaction history, the age range of the customer 201 to which the advertisement is to be presented (e.g., 20-30 year old), the income level range of the customer 201 to which the advertisement is to be presented, the credit score range of the customer 201 to which the advertisement is to be presented, the deposit account balance range of the customer 201 to which the advertisement is to be presented, proximity of the customer's home address or place of employment address to a location of the merchant, sex of the customer, etc.

It is noted that the characteristics the advertiser 215 may choose in order to target the advertising are not limited to the characteristics described above. Instead, the characteristics described above are merely illustrative.

As discussed above, the advertiser's advertising account may be part of a web based system 219 and include fields for the advertiser 215 to enter characteristics of the intended audience to which the advertiser 215 would like the advertisement displayed.

As described above, according to aspects of the disclosure, the advertising system 200 may include an advertisement optimization engine 211. The advertisement optimization engine 211 may determine which advertisement stored in the advertisement repository 213 should be displayed to the customer 201 during a particular transaction. For example, according to aspects of the disclosure, the advertisement optimization engine 211 may use the characteristics of the intended audience to which the advertiser 215 would like an advertisement displayed in determining which advertisement to display to the customer 201 during a transaction.

According to aspects of the disclosure, once the advertiser 215 has provided which characteristics of the intended audience to which the advertiser 215 would like the advertisement displayed, the list of characteristics may be stored with the advertisement and uploaded to the advertising system 200 via the computer system 217. The characteristics will remain associated with the advertisement itself. Therefore, the advertisement, along with the characteristics of the intended audience to which the advertiser 215 would like the advertisement displayed, may be stored in the advertisement repository 213 upon being approved by the organization 203.

As discussed above, according to aspects of this disclosure, the advertisement optimization engine 211 may determine which advertisements stored in the advertisement repository 213 should be presented to customer 201 during a particular transaction. According to aspects of the disclosure, when a transaction is conducted, the point of transaction 205 may transmit information regarding the transaction to the advertisement optimization engine 211. Such information regarding the transaction itself may include: that a transaction is actually being conducted; the type of transaction (e.g., withdrawal, deposit, balance inquiry, transfer of funds, etc.); the type of point of the transaction through which the transaction is being conducted (e.g., whether transaction is occurring at ATM, counter transaction, online transaction, telephone transaction, etc.); the location of the point of the transaction, the date of the transaction, time of the transaction, etc. Further, according to aspects of the disclosure, some form of authentication may be required by the customer 201 in order to conduct the transaction (e.g., one or more of the authentication methods described above may be employed). In such a case, the authentication system 207 may authenticate the customer 201 including transmitting data related to the authentication to the organization's database 209 and also the advertisement optimization engine 211. It is noted that, as seen in FIG. 2, the advertisement optimization engine 211 may also receive data from the organization's database 209. According to aspects of the disclosure, in authenticating the customer 201 conducting a transaction, the identity of the customer 201 is obtained. For example, the authentication system 207 may request and receive such information from the organization's database 209. Further, either, or both, of the authentication system 207 and the organization's database 209 may transmit such identity information to the advertisement optimization engine 211. Therefore, using the identity of the customer 201 who is being authenticated, the advertisement optimization engine 211 can request and receive additional information from the organization's database 209 about customer 201. It is noted that such information about the customer 201 may be stored in a customer profile in the organization database 209. According to aspects of the disclosure, customer profile information may include data about current customers and their financial relationships with the business, such as: customer name, address, telephone number, email address, age, sex, credit score, income, debt, place of employment (and its contact information, such as address, telephone numbers, etc.), the type of financial relationship/account (e.g., a loan, insurance, savings account, checking account, etc.), term of the relationship (e.g., term of a loan, the time current customer has been with the bank), account balances, transaction history (including trends in banking history (e.g., ATM usage) etc.), etc.

Hence, it is understood that the advertisement optimization engine 211 may receive customer profile data from the organization's database 209 and the authentication system 207, transaction data from the point of transaction 205 and the authentication system 207 and leverage such data to determine which advertisement to present to the customer 201 during the transaction. According to aspects of the disclosure, the advertisement optimization engine 211 may compare customer profile data and transaction data with the advertisements stored in the advertisement repository 213 along with the advertisement's associated characteristics of the intended audience to which the advertiser 215 would like the advertisement displayed. Based on the comparison of such information, the advertisement optimization engine 211 may determine which advertisement to retrieve of the advertisement repository 213 and present to the customer 201 during the transaction.

For example, according to aspects of the disclosure, as described above, the advertisement optimization engine 211 may receive transition data from the point of transaction 205. The advertisement optimization engine 211 may compare one or more elements of this transaction data with the above described characteristics of the advertisements stored in the advertisement repository 213 in order to determine one or more advertisements that may be presented to the customer 201 during the transaction. For example, advertisement optimization engine 211 may compare what type of transaction is being conducted (e.g., withdrawal, deposit, balance inquiry, transfer of funds, etc.), the type of the point of transaction 205 at which the transaction is being conducted, (e.g., an ATM, counter transaction, online transaction, telephone transaction, etc.), the location of the point of the transaction, the date of the transaction, the time of the transaction, with the advertisements and their respective categories of characteristics of the intended audience to which the advertiser 215 would like the advertisement displayed. If there are any advertisements stored in the advertisement repository 213 which have one or more characteristics of the intended audience to which the advertiser 215 would like the advertisement displayed that correspond to the transaction data received from the point of transaction 205, then the advertisement optimization engine 211 may consider such advertisements as potential advertisements to be presented to the customer 201 during the transaction. For example, in regard to the first characteristic described above (i.e., the type of transaction is being conducted, such as a withdrawal, deposit, balance inquiry, transfer of funds, etc.), if the transaction data indicates that the transaction is a withdrawal, then the advertisement optimization engine 211 may display a first advertisement to the customer 201 during the transaction which is different than a second advertisement that may be displayed to a customer if the customer was making a deposit. Hence, it is understood that according to aspects of the disclosure, the advertisement presented to the customer may be activity specific (i.e., based on the type of transaction is being conducted). According to other aspects of the disclosure, characteristics may be used in combination to determine the particular advertisement to be presented to the customer. For example, if the transaction data indicates that a withdrawal of $100 is being is being conducted at an ATM at the intersection of 13^{th} and L Streets on November 28 at 11:00 pm and one or more of the advertisements includes characteristics of the intended audience that correspond to such data (e.g., an advertisement has characteristics of the intended audience which include: withdrawals of over $50 from an ATM between 7:00 pm and 1:00 am), then the advertisement optimization engine 211 may consider such advertisements as potential advertisements to be displayed to the customer 201 during the transaction. It is noted that according to aspects of the disclosure, the potential advertisements may be prioritized according to the number of different characteristics that match the transaction data. In other words, advertisements which have the most associated characteristics of the intended audience that match the transaction data may be ranked higher in a list of potential advertisements to be presented to a customer 201, than advertisements which have less associated characteristics of the intended audience that match the transaction data.

Similarly, according to aspects of the disclosure, as described above, the advertisement optimization engine 211 may receive information from authentication system 207 and the organization database 209 regarding the customer 201 conducting the transaction. According to aspects of the disclosure, in order to determine one or more advertisements that may be presented to the customer 201 during the transaction, the advertisement optimization engine 211 may compare one or more elements of this data with the above described characteristics of the intended audience to which the advertisements stored in the advertisement repository 213 are to be presented. For example, advertisement optimization engine 211 may compare the customer data with: the age range of the customer 201 to which the advertisement is to be presented, the income level range of the customer 201 to which the advertisement is to be presented, the credit score range of the customer 201 to which the advertisement is to be presented, the deposit account balance range of the customer 201 to which the advertisement is to be presented, the proximity range of the customer's home address to a location of the merchant, the proximity range of the address of the customer's place of employment to a location of the merchant, sex of the customer, transaction history criteria of the customer, or other characteristics of the intended audience to which the advertisements are to be presented. If there are any advertisements stored in the advertisement repository 213 which have one or more characteristics of the intended audience to which the advertiser 215 would like the advertisement displayed that correspond to the customer data received from the authentication system 207 or the organization database 209, then the advertisement optimization engine 211 may consider such advertisements as potential advertisements to be displayed to the customer 201 during the transaction. For example, if the customer data indicates that the customer 201 is a 25 year old male with an income of $40,000 and the advertisement repository 213 has one or more of advertisements which have characteristics of the intended audience that correspond to such data (e.g., the characteristics of the intended audience of an advertisement include males between 20-30), then the advertisement optimization engine 211 may consider such advertisements as potential advertisements to be displayed to the customer 201 during the transaction. It is noted that according to aspects of the disclosure, the potential advertisements may be prioritized according to the number of different characteristics that match the customer data. In other words, advertisements which have the most associated characteristics of the intended audience that match the customer data may be ranked higher in a list of potential advertisements to be presented to a customer 201 than advertisements which have the less associated characteristics of the intended audience that match the customer data.

It is noted that, as described above, according to aspects of the disclosure, the advertisement optimization engine 211 may receive information from the organization database 209 regarding the customer 201 conducting the transaction. Such customer information may include the transaction history of the customer 201. For example, itemized purchases of the customer 201 may be included in the transaction history. The advertisement optimization engine 211 may leverage this customer data to determine one or more advertisements to be presented to the customer 201 during the transaction. For example, if the customer 201 usually makes purchases from a particular eatery, and an advertisement for that eatery is stored in the ad repository 213, then the advertisement optimization engine 211 may display the advertisement for that eatery. It is noted that such information (e.g., the top five merchants from which the customer 201 purchases may be already determined and stored in the customer profiles for quick reference). Further, such information may also be correlated and combined with other of the listed characteristics (e.g., the time of day, date, etc.). For example, if the customer 201 usually purchases from a particular eatery for lunch and, also, purchases from a different, particular eatery for dinner, the advertisement optimization engine 211 may display different advertisements depending on the time of day the transaction is made (e.g., the advertisement optimization engine 211 may present a coupon for the first eatery, if a transaction is made during the day or the advertisement optimization engine 211 may present a coupon for the second eatery if a transaction is made during the evening). Additionally, the advertisement optimization engine 211 may tailor the advertisement based on the specific customer's personal transaction history. For example, if the advertisement optimization engine 211 receives information from the transaction history which indicates that a particular customer normally spends $10 at a particular business, then the advertisement optimization engine 211 may present to the customer a coupon for a discount of 10%. However, if the advertisement optimization engine 211 receives information from the transaction history which indicates that the particular customer normally spends $50 at a particular business, then the advertisement optimization engine 211 may present to the customer a coupon for a discount of 20%. Of course, the advertisement optimization engine 211 may customize the advertisement based on of criteria as well. Further, it is noted that according to aspects of the disclosure, such transaction history information can also be used by an advertiser to focus the particular audience to which the advertiser would like the advertisement displayed. For example, the advertising account may have a feature which allows the advertiser 215 to define a characteristic of the transaction data for the intended audience to which the advertisement should be displayed. For example, the advertiser may define that if transaction history of the customer indicates that they have made at least five purchases from the merchant in the past year, then such a customer making a transaction should be included as part of the intended audience to which the advertisement should be displayed.

Therefore, based on the above discussion, it is understood, the advertisement optimization engine 211 may determine one or more advertisements to be presented to the customer 201 during the transaction, based on the comparison of the customer data, transaction data, transaction history, etc. with the advertisements that are stored in the advertisement repository 213 and their characteristics of the intended audience to which the advertiser 215 would like the advertisements displayed. For example, according to aspects of this disclosure the potential advertisements may be prioritized according to the total number of different characteristics that match the both the transaction data and customer data. In other words, advertisements which have the most associated characteristics of the intended audience that match the transaction data and the customer data may be ranked higher in a list of potential advertisements to be presented to a customer 201 than advertisements which have less associated characteristics of the intended audience that match the transaction data on customer data. Further, if the transaction data indicates a particular trend in the customer's transaction history, then an advertisement for product or service related to that transaction history may be given priority of over other advertisements.

Further, it is noted that the advertisement optimization engine 211 may consider other factors also in determining which advertisement to select and present to a customer during a transaction. For example, according to aspects of this disclosure, the advertisement optimization engine 211 may consider if a particular quota of times that an advertisement is scheduled to be displayed has not yet been met. If not, then the advertisement optimization engine 211 may give that advertisement priority over other advertisements. Further, the advertisement optimization engine 211 may consider factors such as the frequency with which an advertisement has already been displayed or if an advertisement is near expiration when a particular quota of times that an advertisement is scheduled to be displayed has not yet been met may be used.

As discussed above, according to aspects of the disclosure, the advertising system 200 provides several benefits for the advertisers 215 who participate in the advertising system 200. As also discussed above, one such benefit of the advertising system 200 is that it may provide feedback to the advertiser 215 on the effectiveness of the advertisements. For example, the advertising system 200 may analyze financial transaction data to determine many aspects related to the effectiveness of the advertisement. For example, if the advertisement is more effective in particular location, during a particular time of day, or time of the year or month, if a particular advertisement is viewed for a longer amount of time or by a larger group of people than a second of the advertiser's advertisement, etc. The advertising system 200 could then leverage such information in order to determine if the advertiser 215 should consider modifying one or more of their advertisements or their entire advertising campaign in order to increase its effectiveness, and provide feedback corresponding to the determination. It is noted that organization 203 may have privacy guidelines that describe the policies regarding the handling of any data related to a customer that may contain private information (e.g., personal identification information, bank card numbers, etc.). Financial transaction data, in some embodiments, may contain such private information. According to aspects of the disclosure, in some embodiments, advertising system 200 may provide feedback that conforms to the policies set forth in the privacy guidelines. According to aspects of the disclosure, advertising system 200 may provide feedback to the advertiser 215 that does not include a customer's private information (e.g., name or other identifying information, etc.). In some embodiments, advertising system 200 may provide feedback wherein a customer's private information has been removed. For example, advertising system 200 may provide feedback at an aggregate level. As another example, advertising system 200 may provide feedback that does not identify any individual and/or include other identifying information such as a bank card number. As another example, advertising system 200 may limit the financial transaction data so that a customer's private information is not analyzed by advertising system 200 when determining aspects related to the effectiveness of an advertisement.

As discussed above, according to aspects of the disclosure, the advertising system 200 may include a transaction data analyzer 223. In some embodiments, the transaction data analyzer 223 may analyze financial transaction data to determine many aspects related to the effectiveness of the advertisement.

In these embodiments, computer system 217 and/or transaction data analyzer 223 could then leverage such information in order to provide feedback to the advertiser 215 on the effectiveness of advertisements. In other embodiments, computer system 217 may be configured to perform the same functions as the transaction data analyzer 223. In other embodiments, the functionality of the transaction data analyzer 223 may be distributed throughout the components of the advertising system 200 (e.g., functionality distributed between advertisement repository 213, advertisement optimization engine 211, organizations databases 209, computer system 217, etc.). The details of these embodiments are the same as that of the transaction data analyzer, except the manner in which the transaction data analyzer 223 functionality is distributed, and, therefore, will not be elaborated on for the sake of brevity.

According to aspects of the disclosure, the transaction data analyzer 223 may leverage information stored in the one or more organization databases 209, including various types of financial transaction data. According to aspects of the disclosure, the transaction data analyzer 223 may leverage the information determined about a transaction conducted at the point of transaction 205. For example, the transaction data analyzer 223 may leverage the information determined about a transaction that was conducted, including: the type of transaction conducted, the type of point of transaction through which the transaction was conducted, the date the transaction was conducted, the length of time over which the transaction was conducted, the amount of funds involved in the transaction, etc. For example, transaction data analyzer 223 may search the information stored in the one or more organization databases 209 for financial transaction data involving a particular type of point of transaction (e.g., ATM). Transaction data analyzer 223 may then determine aspects related to the effectiveness of advertising based on these transactions. For example, transaction data analyzer 223 may determine which advertisements were presented to customers at the point of transaction. As another example, transaction data analyzer 223 may determine, for each advertisement presented to a customer at the point of transaction, if the transaction history for a customer presented with the advertisement contains one or more transactions involving the advertiser associated with the presented advertisement.

According to aspects of the disclosure, the transaction data analyzer 223 may leverage the information determined about the presentation of an advertisement to the customer 205 during the transaction. For example, transaction data analyzer 223 may leverage information determined about the presentation of an advertisement, including: information related to how frequently an advertisement was presented to customers, information related to whether the customer pressed a button to learn more about an advertisement, information related to whether a portion or the entire advertisement has been viewed, information related to customer requests of more information about an advertisement, etc. For example, transaction data analyzer 223 may first determine information related to customer requests of more information about a presented advertisement (e.g., whether the customer requested additional information, or printed a coupon), then transaction data analyzer 223 may then determine whether transactions having such requests, made the advertisement more effective (e.g., the customer used the coupon sooner than other customers whom were presented with the advertisement, but did not request the coupon, and later transacted with the advertiser associated with the coupon).

According to aspects of the disclosure, the transaction data analyzer 223 may leverage the information related to the characteristics of the intended audience to which an advertiser 215 would like an advertisement displayed. As discussed above, such characteristics may include information regarding the transaction itself and information about the customer 201 who is conducting the transaction, etc. For example, transaction data analyzer 223 may search the financial transaction data for transactions where a particular advertisement was presented to customers having characteristics matching the characteristics of the particular advertisement's intended audience (e.g., affluence level, age, gender, location, etc.). In this example, transaction data analyzer 223 may then determine if such customers later transacted with the advertiser associated with the particular advertisement. In some embodiments, transaction data analyzer 223 may accomplish this by searching the transaction history for the customer stored in the one or more organization databases 209. Similarly, according to aspects of the disclosure, the transaction data analyzer 223 may leverage the information related to the characteristics of a transaction entered by an advertiser 215 to selectively present advertisements to customers 201. As discussed above, such characteristics may include the type of the transaction, the type of point of transaction through which the transaction is conducted, the date of the transaction, the time of the transaction, the location of the transaction, the location of the transaction in relation to its proximity to one of the advertiser's location, etc.

According to aspects of the disclosure, the transaction data analyzer 223 may leverage the information contained in the advertisement repository 213. As discussed above, advertisement repository 213 may include advertisements and information associated with respective advertisements. For example, the transaction data analyzer 223 may compare information related to a financial transaction with the information stored in the advertisement repository 213 to present the advertiser 215 with an advertisement that is likely to interest a particular type of customer the advertiser desires to target.

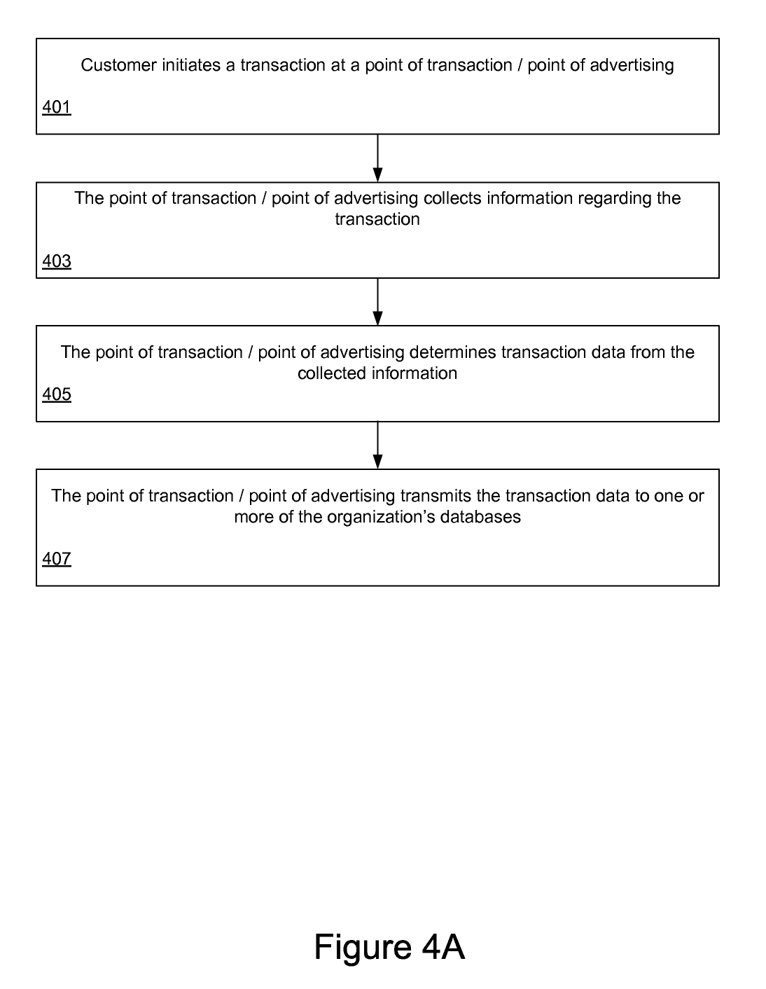

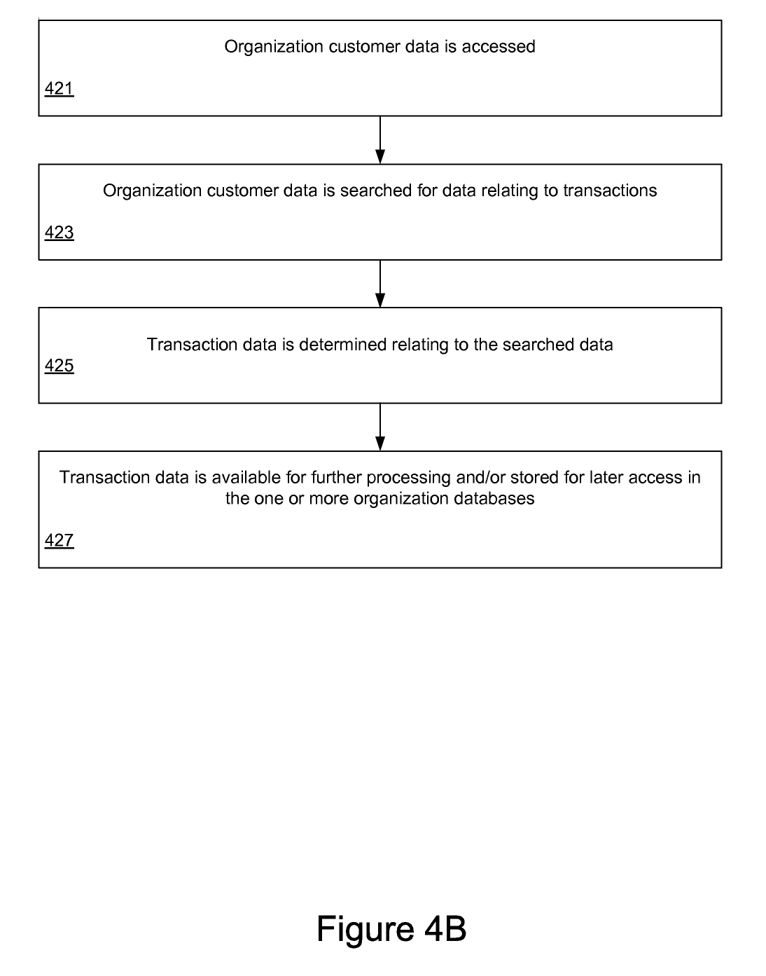

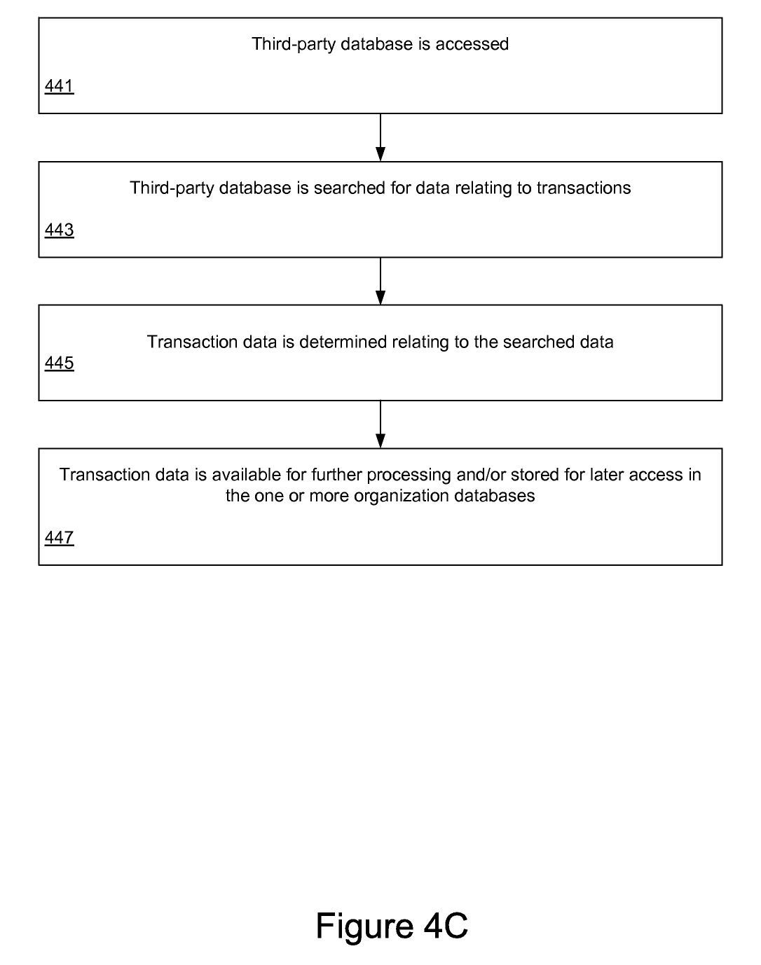

According to aspects of the disclosure, and as discussed above, transaction data analyzer 223 may leverage various types of information related to a financial transaction. In some embodiments, advertising system 200 may determine financial transaction data, which can then be leveraged by the transaction data analyzer 223, from various sources. FIG. 4A, 4B and 4C are a series of flow charts which demonstrate an illustrative method for determining particular types of transaction data according to aspects of the disclosure. FIG. 4A is a flow chart which demonstrates an illustrative method for determining financial transaction data according to an aspect of the disclosure. As seen in FIG. 4A, in step 401, a customer 201 initiates a transaction at a point of interaction/point of advertising 205. In step 403, the point of interaction 205 collects information regarding the transaction. In step 405, the point of interaction 205 determines information related to a financial transaction from the collected information. In step 407, the point of interaction 205 transmits the determined information to the one or more organization databases 209.

According to aspects of the disclosure, in some embodiments, transaction data analyzer 223 may determine information related to a financial transaction from additional sources. In some embodiments, such information may be collected from the customer profiles in the organizations databases 209. As discussed above, customer profile information may include data about current customers and their financial relationships with the business, such as: customer name, address, telephone number, email address, age, sex, credit score, income, debt, place of employment (and its contact information, such as address, telephone numbers, etc.), the type of financial relationship/account (e.g., a loan, insurance, savings account, checking account, etc.), term of the relationship (e.g., term of a loan, the time current customer has been with the bank), account balances, transaction history (including trends in banking history (e.g., ATM usage) etc.), etc.

FIG. 4B is a flow chart which demonstrates an illustrative method for determining information related to a financial transaction according to an aspect of the disclosure. As seen in FIG. 4B, in step 421, the customer profiles are accessed. In step 423, the customer profiles are searched for data relating to financial transactions. In step 425, financial transaction data is determined relating to the searched data. In step 427, the transaction data is available for further processing and/or stored for later access in the one or more organization databases.

According to aspects of this disclosure, in some embodiments, advertising system 200 may determine information related to a financial transaction from third-party sources. For example, advertising system 200 may have access to one or more third-party databases having information stored thereon that relates to financial transactions. For example, an advertiser 215 may provide organization 203 with access to databases that include data related to customers of the advertiser 215, such as customer purchases. For example, a pizza parlor who wishes to advertise with the organization 203 may provide the advertising system 200 access to a database containing data related to the pizza parlor's customer purchases. According to aspects of this disclosure, this data may be accessed and/or searched to determine information related to a financial transaction.

FIG. 4C is a flow chart which demonstrates an illustrative method for determining information related to a financial transaction according to an aspect of the disclosure. As seen in FIG. 4C, in step 441, a third-party database is accessed. In step 443, the third-party database is searched for data relating to a financial transaction. In step 445, information related to a financial transaction is determined based on the searched data. In step 447, the determined information is available for further processing and/or stored for later access in the one or more organization databases 209.

As discussed above, a benefit of the advertising system 200 is that it may provide feedback to the advertiser 215 on the effectiveness of the advertisement. According to aspects of the disclosure, transaction data analyzer 223 may leverage information (e.g., information relating to a financial transaction, information stored in the organizations databases, financial transaction data, etc.) so that advertising system 200 may provide such feedback. The information that may be leveraged by the transaction data analyzer 223 was discussed in detail above. For example, according to aspects of the disclosure, information may be leveraged by the transaction data analyzer 223 to determine the effectiveness of an advertisement, to determine which advertisements are more effective towards a particular type of customer, etc.

According to aspects of the disclosure, the transaction data analyzer 223 may leverage the information to determine many aspects related to the effectiveness of advertising. According to aspects of the disclosure, to determine the effectiveness of advertising, the transaction data analyzer 223 may determine relationships within the information. For example, the transaction data analyzer 223 may analyze the transaction data to determine if an advertisement is more effective in a particular location, during a particular time of day, or time of the year or month, if a particular advertisement is viewed for a longer amount of time or by a larger group of people than a second of the advertiser's advertisement, if a transaction with an advertiser is within a predetermined amount of time from a presentation of an advertisement associated with the advertiser, etc. For example, if the transaction data analyzer 223 is determining the effectiveness of advertising, transaction data analyzer 223 may compare one or more elements of the information in order to determine one or more advertisements that may be effective to one or more characteristics of a particular audience. For example, transaction data analyzer 223 may compare the type of transaction (e.g., withdrawal, deposit, balance inquiry, transfer of funds, etc.), the type of the point of transaction 205 (e.g., an ATM, counter transaction, online transaction, telephone transaction, etc.), the location of the point of the transaction, the date of the transaction, the time of the transaction, the information in the customer profile (e.g., transaction history, etc.), and/or the advertisements and their respective categories of characteristics of the intended audience that are stored in the advertisement repository 213, with the one or more characteristics of a particular audience. If there are any transactions which have one or more characteristics of the particular audience, transaction data analyzer 223 may determine whether advertisements were presented during those transactions. For any advertisement presented, the transaction data analyzer 223 may determine whether the transaction data with the one or more characteristics of a particular audience also includes a transaction involving an advertiser associated with a presented advertisement. If such a transaction exists, transaction data analyzer 223 may communicate feedback related to the presented advertisement of that associated advertiser (e.g., feedback identifying the advertisement). For example, if a transaction indicates that an ATM withdrawal of $100 matches the one or more characteristics of the particular audience, then the transaction data analyzer 223 may identify any advertisement presented during that ATM withdrawal. For any presented advertisement, the transaction data analyzer may then identify the advertiser associated with the presented advertisement from data stored in the advertisement repository 213. Transaction data analyzer 223 may then determine if any other transaction matching the one or more characteristics of the particular audience include the associated advertiser. For example, if another transaction having one or more characteristics of the particular audience indicates that on December 19 at 5:00 PM a purchase was made from the associated advertiser, transaction data analyzer 223 may provide feedback related to this presented advertisement. For example, transaction data analyzer 223 may communicate this presented advertisement to the advertiser 215, and/or information related to the presented advertisement, with further indications that this advertisement was presented during a transaction having one or more characteristics of the particular audience and that another transaction having one or more characteristics of the particular audience involves the advertiser associated with the presented advertisement. It is noted that according to aspects of the disclosure, the feedback may be prioritized according to the number of different characteristics that match the transaction data. In other words, transactions which have the most associated characteristics of the particular audience that match the transaction data may be placed higher, ranked higher, and/or include more information than transactions which have less associated characteristics of the particular audience that match the transaction data.

Further, according to aspects of the disclosure, the one or more characteristics of the particular audience may include characteristics as discussed above with respect to the characteristics of an advertiser's intended audience. For example, the one or more characteristics of the particular audience may be 25 year old males. According to aspects of the disclosure, in addition to the characteristics of an intended audience, the one or more characteristics of the particular audience may include: an age range, an income level range, a credit score range, a deposit account balance range, a proximity range of home addresses to a location of a merchant, a proximity range of place of employment addresses to a location of a merchant, or transaction history criteria of a particular audience. For example, the one or more characteristics may be males with an income greater than $40,000.

As another example, if the transaction data analyzer 223 is determining the effectiveness of advertising, transaction data analyzer 223 may compare one or more elements of the information in order to determine one or more elements of the information that are common to transactions involving an advertiser associated with a particular advertisement. For example, transaction data analyzer 223 may compare the type of transaction (e.g., withdrawal, deposit, balance inquiry, transfer of funds, etc.), the type of the point of transaction 205 (e.g., an ATM, counter transaction, online transaction, telephone transaction, etc.), the location of the point of the transaction, the date of the transaction, the time of the transaction, the information in the customer profile (e.g., transaction history, etc.), and/or the advertisements and their respective categories of characteristics of the intended audience that are stored in the advertisement repository 213, with the information relating to a particular advertisement. If there are any transactions which have the information relating to a particular advertisement, transaction data analyzer 223 may determine one or more characteristics of the audience involved in those transactions. In some embodiments, transaction data analyzer 223 may provide feedback based on the one or more characteristics of the audience involved in those transactions. For example, if the information relating to a particular advertisement identifies a particular advertisement, transaction data analyzer 223 may determine transactions wherein the particular advertisement was presented. If a transaction indicates that an ATM withdrawal of $100 involving a 26 year old male with an income level of $40,000, occurred at 7:00 PM, and another transaction indicates that an ATM deposit of $1000 involving a 35 year old female with an income level of $90,000, occurred at 7:00 PM, then the transaction data analyzer 223 may provide feedback relating to these characteristics (e.g., listing and/or tabulating the characteristics to which the advertisement was presented). Additionally, the transaction data analyzer 223 may determine whether the one or more characteristics of a transaction matches and/or is similar to the one or more characteristics of other transactions, and provide feedback based on the matching/similar one or more characteristics. For example, if the information relating to a particular advertisement identifies a particular advertisement, transaction data analyzer 223 may determine transactions wherein the particular advertisement was presented. If a transaction indicates that an ATM withdrawal of $100 involving a 26 year old male with an income level of $40,000, occurred at 7:00 PM, and another transaction indicates that an ATM deposit of $1000 involving a 35 year old female with an income level of $90,000, occurred at 7:00 PM, then the transaction data analyzer 223 may determine that only the time at which the transaction occurred matches. Accordingly, transaction data analyzer 223 may provide feedback related to this common characteristic (e.g., the advertisement was commonly presented at 7:00 PM). Alternatively, the transaction data analyzer 223 may determine that one or more of the characteristics of those transactions are similar (e.g., type of transactions are similar, amount involved in the transaction is similar, age of audience involved is similar, etc.) and provide feedback related to any such similar one or more characteristics. Further, in some embodiments, transaction data analyzer 223 may analyze the one or more characteristics to determine whether there are one or more advertisements that are effective for these one or more characteristics. In these embodiments, transaction data analyzer 223 would proceed similarly to the manner in which the transaction data analyzer 223 determined one or more advertisements that may be effective to one or more characteristics of a particular audience, as discussed above, except the one or more characteristics of a particular audience would be the one or more characteristics of this embodiment.

Further, according to aspects of the disclosure, the transaction data analyzer 223 may consider various other criteria when leveraging the information to determine many aspects related to the effectiveness of advertising. For example, such criteria may include: information related to particular products or services involved in an advertisement, information related to when the advertisement presentation occurred, and/or information related to when the transaction involving an associated advertiser occurred. For example, transaction data analyzer 223 may determine the effectiveness of the advertisement based on transactions involving the advertiser occurring within a particular time of the presentation of the advertisement. To illustrate how the feedback provided would change based on these criteria the previous example of the transaction data analyzer 223 determining effectiveness based on one or more characteristics of a particular audience may be revisited. In that example, if a transaction indicates that an ATM withdrawal of $100 matches the one or more characteristics of the particular audience, then the transaction data analyzer 223 may identify any advertisement presented during that ATM withdrawal. For any presented advertisement, the transaction data analyzer may then identify the advertiser associated with the presented advertisement from data stored in the advertisement repository 213. Transaction data analyzer 223 may then determine if any other transaction matching the one or more characteristics of the particular audience include the associated advertiser. However, if such a transaction including the associated advertiser occurs after the particular time of the presentation of the advertisement, then transaction data analyzer 223 would ignore the transaction. For example, if the particular time is two days after the presentation of the advertisement, then transactions having one or more characteristics of the particular audience and involving the associated advertisement will be considered only if they occur within two days of the time of the advertisement presentation. Thus, only transactions having one or more characteristics of the particular audience, including the associated advertiser, and occurring before the particular time of the presentation of the advertisement will be considered by the transaction data analyzer 223 when making its determinations and providing feedback

It is noted that, as described above, according to aspects of the disclosure, the transaction data analyzer 223 may receive customer information from the organization database 209. Such customer information may include the transaction history of the customer 201. For example, itemized purchases of a customer may be included in the transaction history. The transaction data analyzer 223 may leverage this customer data to determine one or more advertisements that have been effective to a customer. For example, if a usually makes purchases from a particular eatery, and an advertisement for that eatery is stored in the ad repository 213, then the transaction data analyzer may provide feedback related to the advertisement for that eatery (e.g., this advertisement is likely to be effective for this customer). It is noted that such information (e.g., the top five merchants from which a customer purchases may be already determined and stored in the customer profiles for quick reference). Further, such information may also be correlated and combined with other of the listed characteristics (e.g., the time of day, date, etc.). For example, if a customer usually purchases from a particular eatery for lunch and, also, purchases from a different, particular eatery for dinner, the transaction data analyzer 223 may provide feedback indicating these differences. Further, it is noted that according to aspects of the disclosure, such transaction history information can also be used by the transaction data analyzer 223 to provide feedback to the advertiser related to focusing the particular audience to which the advertiser would like the advertisement displayed. For example, the transaction data analyzer may provide feedback which indicates characteristics to which the advertisement should be displayed, and is likely to be most effective. For example, the transaction data analyzer 223 may determine that the transaction history of a customer indicates that they have made at least five purchases from the merchant in the past year, then the characteristics of such a customer should be included as part of the intended audience to which the advertisement should be displayed, and the feedback may indicate these characteristics.

According to aspects of the disclosure, the transaction data analyzer 223 provide the feedback to the advertiser directly, as discussed above, or the transaction data analyzer 223 may store the results in the one or more organization databases 209, and/or make the organized results available for further processing. According to aspects of the disclosure the transaction data analyzer 223 may provide the feedback, store the results, and/or organize the results in various formats. For example, the transaction data analyzer 223 may provide feedback as text (e.g., text indicating the determined effectiveness, such as, for example: “Advertisement A was presented 4 times, and 2 customers later purchased from store B”; “Advertisement B was presented 5 times on Dec. 19, 2009, and 4 customers later purchased from store C”; “Advertisement C was presented 2 times during the period between 7:00 PM and 8:00 PM and 0 customers presented with the advertisement purchased from the advertiser associated with Advertisement C”; “Advertisement D was presented 8 times and 3 customers purchased from Advertiser D within 3 days of being presented with the advertisement”; “Advertisement E was presented 23 times and was most effective when presented on an ATM”; “Advertisement F was presented 14 times and was most effective during the time between 5:00 PM and 7:00 PM”; “Advertisement G was presented 10 times and was least effective when presented to males between the ages of 20-30 years old”, etc.). As another example, the transaction data analyzer 223 may provide feedback as a rank-order list. In this example, a rank- order list may include a list of advertisements effective towards a particular customer (e.g., top-5 most effective advertisements), a list of customers wherein the advertisement was effective (e.g., 5 customers the advertisement was most affective towards), a list of type of customers wherein the advertisement was effective, etc. As another example, the transaction data analyzer 223 may provide feedback as an effectiveness rating (e.g., a computed score between 0-100, alphanumeric grade, etc.). As another example, the transaction data analyzer 223 may provide feedback in a table format. In this example, a table format may summarize the results in an easy to read format. As another example, the transaction data analyzer 223 may provide feedback in a graphical format (bar graph, pie chart, etc.). As another example, the transaction data analyzer 223 may combine one or more formats when providing feedback, such as combining a rank-order list and a table format.

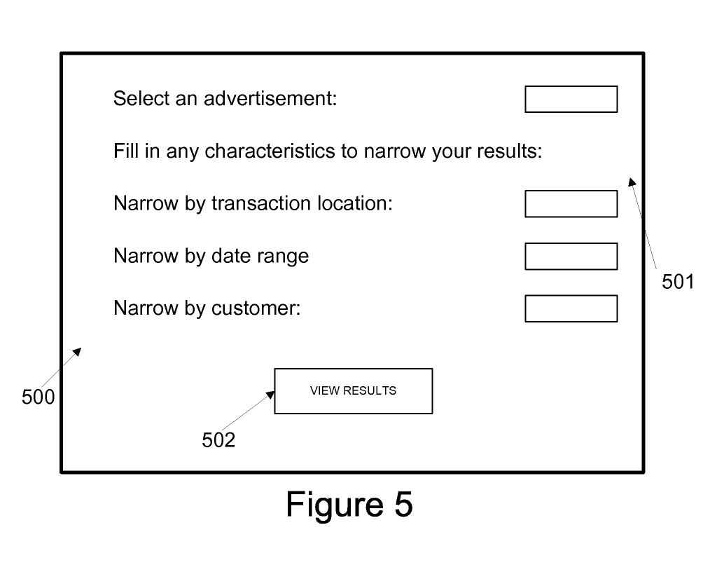

According to aspects of the disclosure, the advertising system 200 may include a feature that allows the advertiser 215 to receive feedback on whether particular advertisements are, have been, or may be effective. According to aspects of the disclosure, the advertising system 200 may include a feature that allows the advertiser to receive feedback on effective advertising according to particular characteristics (e.g., a particular customer, a particular type of customer, a particular location, etc.) of transaction data. For example, according to aspects of the disclosure, an advertiser's advertising account for submitting advertisements to the organization's advertising system 200 may include features which allow the advertiser 215 to receive feedback on particular advertisements or particular characteristics of transaction data. For example, FIG. 5 shows an illustrative screen shot 500 of a feature of the advertiser's advertising account in which the advertiser 215 may enter one or more characteristics of a particular audience, enter information related to a particular advertisement (e.g., identify a particular advertisement), and/or information related to other criteria, as discussed above, by which transaction data analyzer 223 performs its analysis. As seen in FIG. 5, the advertiser may identify a particular advertisement and/or enter characteristics in the provided fields 501 and may view the results according to the entered information by pressing the button 502. The entered information is communicated to the transaction data analyzer 223 so that transaction data analyzer 223 may provide feedback based on the entered information. For example, the advertiser's advertising account may be part of a web based system 217 and include fields for the advertiser 215 to enter the desired characteristics and/or the particular advertisement. In this example, the advertiser's input would be transmitted from the web based system 217 to the transaction data analyzer 223 so the transaction data analyzer may perform the analysis, as discussed above, according to the advertiser's input. For example, if the advertiser selects particular advertisements and characteristics, such as a particular age of the customer presented with the particular advertisement, the transaction data analyzer 223 may measure the effectiveness of the particular advertisement according to transactions involving customers presented with the particular advertisement that are the particular age. According to aspects of the disclosure, the web based system 217 of this example may include fields that allow the advertiser to select the manner in which the transaction data analyzer provides feedback (e.g., rank-order list, table format, etc.).

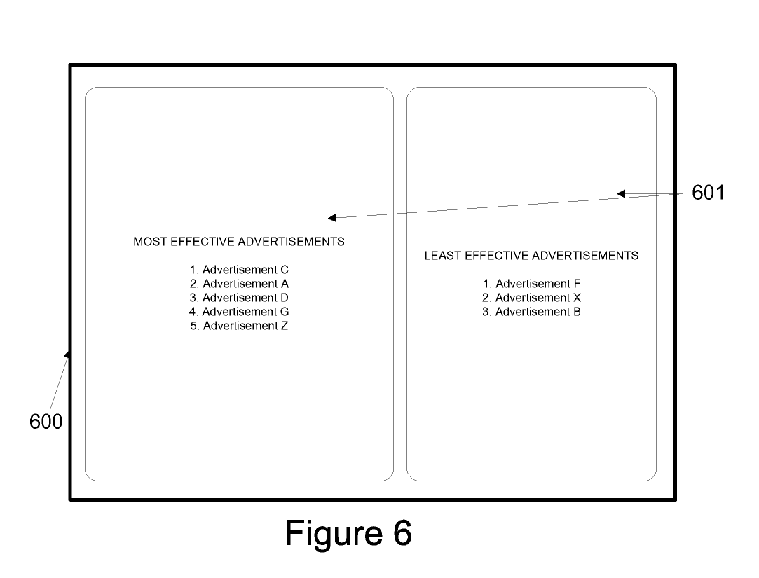

According to aspects of the disclosure, advertising system 200 may include features which allow the advertiser 215 to receive feedback on particular advertisements or particular characteristics of transaction data. For example, the advertiser, upon entering appropriate input to the web based system 217 (e.g., pressing a button on a screen to view results, and/or entering particular characteristics of transaction data and/or particular advertisements), may receive feedback provided by the transaction data analyzer 223. For example, FIG. 6 shows an illustrative screen shot 600 of a feature of the advertiser's advertising account in which the advertiser 215 may receive displayed feedback. As seen in FIG. 6, the screen shot includes one or more areas where the results may be displayed. According to aspects of the disclosure, transaction data analyzer 223 may also send and/or print the formatted results to a location selected by the advertiser.

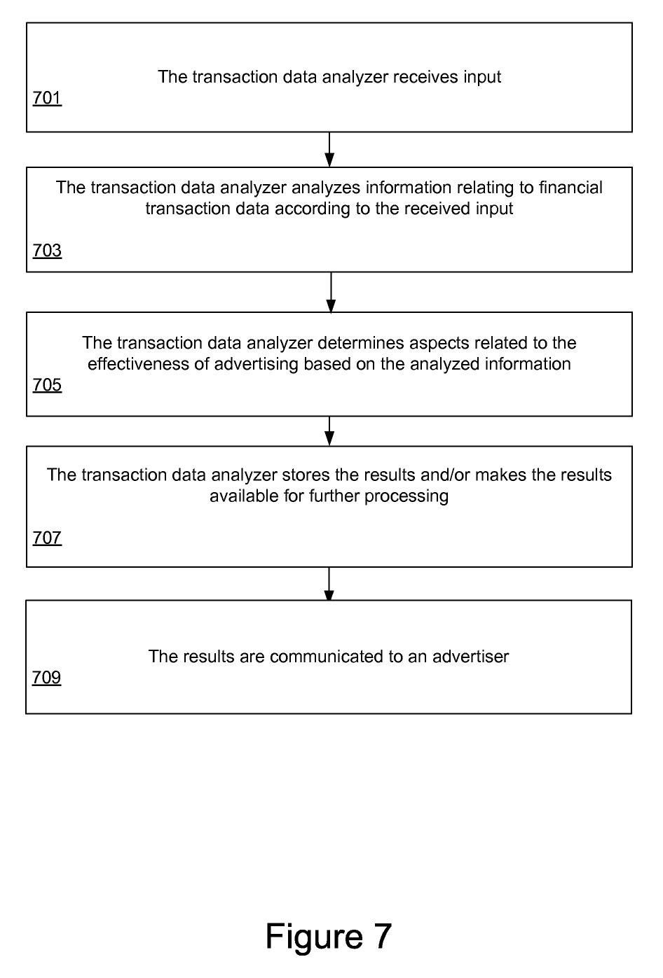

FIG. 7 is a flowchart of an illustrative method for providing feedback to an advertiser related to the effectiveness of advertising. As seen in step 701, the transaction data analyzer 223 receives input. As seen in step 703, the transaction data analyzer 223 analyzes information relating to financial transaction data according to the received input. As seen in step 705, the transaction data analyzer 223 determines aspects related to the effectiveness of advertising based on the analyzed information. As seen in step 707, the transaction data analyzer 223 stores the results and/or makes the results available for further processing. As seen in step 709, the results are communicated to an advertiser. For example, transaction data analyzer 223 may receive input data that identifies a particular advertisement, identifies one or more characteristics of a particular audience, and indicates a time limit for transactions occurring after a presentation of the particular advertisement. In this example, transaction data analyzer 223 may receive input that identifies an advertisement for a pizza parlor, the characteristics of a 27 year old female, and a time period of one week. In this example, upon receiving the input, transaction data analyzer 223 compares the financial transaction data according to this received input. Therefore, in this example, transaction data analyzer 223 will determine the effectiveness of the pizza parlor advertisement with respect to 27 year old females, based on transactions occurring within one week of transactions where 27 year old females were presented with the advertisement for the pizza parlor. Particularly, in some embodiments that receive the input of this example, transaction data analyzer 223 may search transactions occurring within seven days of a presentation to a 27 year old female of the pizza parlor advertisement. In these embodiments, transaction data analyzer 223 may search information related to financial transactions, including the customer profile data and the transaction history of the 27 year old female whom the pizza parlor advertisement was presented, for financial transaction data that represents a financial transaction involving the 27 year old female and the pizza parlor itself within seven days of the advertisement presentation (e.g., purchases made by the 27 year old female at the pizza parlor, coupons used by the 27 year old female at the pizza parlor, etc.). Transaction data analyzer 223 then determines results based on the financial transaction data resulting during the search. For example, transaction data analyzer 223 may determine characteristics of any 27 year old female who was presented with the pizza parlor advertisement and then transacted with the pizza parlor within seven days (e.g., address, affluence level, etc.). As another example, transaction data analyzer 223 may determine characteristics of any transaction where the pizza parlor advertisement was presented to any 27 year old female who later transacted with the pizza parlor within seven days (e.g., type of point of transaction, time of transaction, location of transaction, etc.). Feedback based on these results may then be communicated to an advertiser 215 by computer system 217. For example, feedback may be a table of the determined characteristics and the number each characteristic was found in the relevant financial transaction data (e.g., table of affluence levels having a row for under $40,000, with an associated indication that such affluence level occurred 3 times, and another row for affluence level greater than $40,000 and an indication that such affluence level occurred 1 time). As another example, feedback may be a top-5 list of types of point of transactions. In this example, if there were two types of point of transactions found (e.g., ATM, bank counter), then the type of point of transaction which was found more often would be ranked higher (e.g., if ATM was found 5 times and a bank counter was found 2, then ATM would be ranked 1, and bank counter would be ranked 2). Such feedback, when communicated, may be displayed on a computer display.

As discussed above, according to aspects of this disclosure, information regarding the transaction itself and the presentation of the advertisement to the customer 201 during the transaction may be provided to the advertiser 215 as a value added service. The advertiser 215 may be able to leverage such information provided by the advertising system 200 to analyze the effectiveness of their advertisements and potentially modify their advertising strategy. According to aspects of the disclosure, the advertising system 200 may determine information about the transaction conducted at the point of transaction 205 (a time of the transaction, a date of the transaction, a location of the transaction, etc.) and, further, may transmit such information to the organizations databases 209 to be stored. Further, according to aspects of the disclosure, the advertising system 200 can determine information about the presentation of the advertisement to the customer 201 during the transaction. Further, such information may be also transmitted to and stored in the organizations databases 209. According to aspects of the disclosure, the transaction data analyzer 223 may provide feedback related to the advertisements submitted by the advertiser 215, and stored in the advertisement repository 213, to the advertiser 215 based on this information. For example, in some embodiments, transaction data analyzer 223 may, for each advertisement of the advertiser 215 stored in the advertisement repository 213, search information stored in the organizations databases 209 for financial transaction data related to transactions when each advertisement was presented to a customer 201. Upon completing the search, transaction data analyzer 223 may determine results related to the effectiveness of each advertisement. For example, in some embodiments, transaction data analyzer 223 may identify the customer presented each advertisement and then determine if the transaction history for the identified customer includes a transaction involving the customer and the advertiser 215 occurring after the presentation of the advertisement. In other embodiments, transaction data analyzer 223 may identify the customer presented each advertisement and then determine if the transaction history for the identified customer includes a transaction involving the customer and the advertiser 215 occurring after the presentation of the advertisement and before a predetermined time limit. In other embodiments, transactions data analyzer 223 may identify the time of the transaction when each advertisement was presented, and the identities of the customers involved those transactions, and then determine if the transaction history for each identified customer includes a transaction involving the customer and the advertiser 215 occurring after the presentation of the advertisement. Once the transaction data analyzer 223 has made such a determination for each customer, transaction data analyzer 223 may then determine if particular time periods when the advertisement was presented are more effective. For example, transaction data analyzer may determine that the advertisement is more effective when presented at 7:00 PM than at other times (e.g., customers presented at 7:00 PM were more likely to later transact with the advertiser, customers presented at 7:00 PM conducted the most transactions with the advertiser, customers presented at 7:00 PM purchased the most goods or services of the advertiser, etc.) Further, transaction data analyzer 223 may determine that the advertisement is more effective when presented in a particular time range (e.g., customers presented at 5:00 PM to 7:00 PM were more likely to later transact with the advertiser, etc.). Similarly, transaction data analyzer 223 may determine that the advertisement is ineffective when presented at a particular time, or in a particular time range (e.g., customers presented at 5:00 PM did not later transact with the advertiser, customers presented at 5:00 PM were purchased few to no goods or services of the advertiser, customers presented at 5:00 PM conducted little to no transactions with the advertiser, etc.) Similarly, in other embodiments, transaction data analyzer 223 may perform a similar analysis for a date of transaction (e.g., determine if particular dates, or date ranges, are more effective), and a location of the point of transaction (e.g., determine if particular types of the point of transaction are more effective). Such similar analysis may be performed in the addition, or in the alternative, to the time of transaction, as discussed above. Accordingly, in these embodiments, transaction data analyzer 223 may determine results based on these determinations (e.g., text indicating the most effective time periods, pie chart indicating the effectiveness of the types of point of transaction, table indicating the effectiveness of the date of transactions and including the number of times each advertisement was presented on each date of transactions, text indicating the least effective time periods, etc.) In some embodiments, these results may be provided to the advertiser. Further, in some embodiments, the transaction data analyzer 223 may be configured to perform this analysis at a predetermined time, at periodic intervals, upon an advertiser 215 accessing the advertising system 200, upon a request by the advertiser 215, etc.

It is noted that the advertising system 200 may be an electronically based system. For example, the system may include a computer (such as described above), a network of computers, software that configures a computer to perform the above described features, etc. The data, such as the transaction data, customer data, etc. may be electronically transmitted and received by the different elements of the advertising system 200.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present disclosure. The description is thus to be regarded as illustrative instead of restrictive on the present disclosure.

What is claimed is:

1. A financial transaction analyzing computer system for leveraging financial transaction data to determine the effectiveness of advertising, comprising:
a computer system configured to present an advertisement during a financial transaction and electronically receive data regarding a financial transaction from a point of interaction wherein the financial transaction is conducted;
one or more databases configured to electronically receive the data regarding the financial transaction from the computer system and store the data regarding the financial transaction; and
a transaction data analyzer including:
a processor; and
memory storing computer executable instructions that, when executed, cause the transaction data analyzer to perform a method for leveraging financial transaction data to determine the effectiveness of advertising by:
electronically receiving input from the computer system;
searching the stored data regarding the financial transactions based on the input received from the computer system for financial transaction data;
determining one or more characteristics of the financial transaction data resulting from the search; and
determining one or more results related to advertising effectiveness based on the one or more characteristics.

2. The system of claim 1, wherein the received input includes at least one of the following: one or more characteristics of a particular audience, information related to a particular advertisement, and a time period that provides the transaction data analyzer a time limit for transactions occurring after a presentation of the particular advertisement, wherein the time limit is the time of the presentation of the particular advertisement plus the time period, and the financial transaction data resulting from the search only includes financial transactions occurring before the time limit.

3. The system of claim 1, wherein the computer system transmits the results to the advertiser, and wherein the advertiser has submitted an advertisement for presentation during a financial transaction to the computer system, and the results determined by the transaction data analyzer are related to the effectiveness of the submitted advertisement.

4. The system of claim 1, wherein the computer system further includes an advertisement repository database which stores one or more advertisements and information regarding a particular audience to which the respective advertisements should be presented; and
wherein the transaction data analyzer searches the advertisement repository database based on the received input, and determines the one or more characteristics of the financial transaction data based on information resulting from the search of the advertisement repository.

5. The system of claim 4, wherein the received input includes information that identifies a particular advertisement; and
wherein the transaction data analyzer searches the advertisement repository to identify an advertiser associated with the particular advertisement, the financial transaction data resulting from the search includes one or more transactions involving a customer that was presented with the particular advertisement and the advertiser associated with the particular advertisement, and the one or more characteristics of the financial transaction data determined by the transaction data analyzer includes characteristics of the customer that was presented the particular advertisement.

6. The system of claim 1, wherein the computer system is configured to allow the advertiser to define the input transmitted from the computer system to the transaction data analyzer.

7. The system of claim 1, wherein the financial transaction data includes at least one of: a type of financial transaction being conducted, a type of the point of transaction through which the financial transaction was conducted, a location of the point of transaction wherein the financial transaction was conducted, a date when the financial transaction was conducted, a time when the financial transaction was conducted, and an amount of funds involved in the financial transaction.

8. The system of claim 2, wherein the one more characteristics of a particular audience includes at least one of: a type of financial transaction being conducted, a type of the point of transaction through which the financial transaction was conducted, a location of the point of transaction wherein the financial transaction was conducted, a date when the financial transaction was conducted, a time when the financial transaction was conducted, a time when the financial transaction was conducted, and an amount of funds involved in the financial.

9. The system of claim 1, wherein the one or more characteristics of the financial transaction data includes at least one of: a type of financial transaction being conducted, a type of the point of transaction through which the financial transaction was conducted, a location of the point of transaction wherein the financial transaction was conducted, a date when the financial transaction was conducted, a time when the financial transaction was conducted, a time when the financial transaction was conducted, and an amount of funds involved in the financial.

10. The system of claim 1, wherein a result of the one or more results is an amount of times a particular advertisement has been presented over a predetermined amount of time.

11. The system of claim 1, wherein a result of the one or more results is one or more characteristics of a financial transaction involving an advertiser associated with a particular advertisement.

12. The system of claim 8, wherein the computer system is configured to select transaction data according to input from the user.

13. A computer assisted method for leveraging financial transaction data to determine the effectiveness of advertising, comprising:
selecting an advertisement to be presented to a customer during a financial transaction at a point of transaction, wherein financial transaction data from the financial transaction being conducted at the point of transaction is determined at the point of transaction and transmitted to one or more databases, and wherein the one or more databases stores the financial transaction data; and
determining the effectiveness of advertising based on the stored financial transaction data by:
electronically receiving input at a transaction data analyzer; electronically searching the stored financial transaction data based on the received input;
using the transaction data analyzer to determine one or more characteristics of the financial transaction data resulting from the search; and
determining one or more results related to advertising effectiveness based on the one or more characteristics.

14. The computer assisted method of claim 13, wherein the received input includes at least one of the following: one or more characteristics of a particular audience, information related to a particular advertisement, and a time period that provides the transaction data analyzer a time limit for transactions occurring after a presentation of the particular advertisement, wherein the time limit is the time of the presentation of the particular advertisement plus the time period, and the financial transaction data resulting from the search only includes financial transactions occurring before the time limit.

15. The computer assisted method of claim 13, further comprising:
searching an advertisement repository database based on the received input;
wherein the one or more characteristics of the financial transaction data is determined by the transaction data analyzer based on the information resulting form the search of the advertisement repository; and
wherein the advertisement repository database stores one or more advertisements and information regarding a particular audience to which the respective advertisements should be presented.

16. The computer assisted method of claim 15, wherein the received input includes information that identifies a particular advertisement; and
wherein, during the searching of the advertisement repository, the transaction data analyzer identifies an advertiser associated with the particular advertisement, the financial transaction data resulting from the search includes one or more transactions involving a customer that was presented with the particular advertisement and the advertiser associated with the particular advertisement, and the one or more characteristics of the financial transaction data determined by the transaction data analyzer includes characteristics of the customer that was presented the particular advertisement.

17. The computer assisted method of claim 13, wherein the advertiser defines the input received by the transaction data analyzer.

18. The computer assisted method of claim 13, wherein the financial transaction data includes at least one of: a type of financial transaction being conducted, a type of the point of transaction through which the financial transaction was conducted, a location of the point of transaction wherein the financial transaction was conducted, a date when the financial transaction was conducted, a time when the financial transaction was conducted, and an amount of funds involved in the financial transaction.

19. The computer assisted method of claim 14, wherein the one more characteristics of a particular audience includes at least one of: a type of financial transaction being conducted, a type of the point of transaction through which the financial transaction was conducted, a location of the point of transaction wherein the financial transaction was conducted, a date when the financial transaction was conducted, a time when the financial transaction was conducted, a time when the financial transaction was conducted, and an amount of funds involved in the financial.

20. The computer assisted method of claim 13, wherein the one or more characteristics of the financial transaction data includes at least one of: a type of financial transaction being conducted, a type of the point of transaction through which the financial transaction was conducted, a location of the point of transaction wherein the financial transaction was conducted, a date when the financial transaction was conducted, a time when the financial transaction was conducted, a time when the financial transaction was conducted, and an amount of funds involved in the financial.
